(19) United States
(12) Patent Application Publication
(10) Pub. No.: US 2019/0228180 A1
(43) Pub. Date: Jul. 25, 2019

(54) APPARATUS, METHOD, AND SYSTEM FOR PROVIDING INFORMATI0N AND STORAGE MEDIUM

(71) Applicant: FUJITSU LIMITED, Kawasaki-shi (JP)

(72) Inventors: Wakana Maeda, Kawasaki (JP); Yuji Yamaoka, Kawasaki (JP); Hisashi Kojima, Yokosuka (JP)

(73) Assignee: FUJITSU LIMITED, Kawasaki-shi (JP)

(21) Appl. No.: 16/252,171

(22) Filed: Jan. 18, 2019

(30) Foreign Application Priority Data
Jan. 22, 2018 (JP) 2018-008423

(51) Int. Cl. G06F 21/62; G06F 16/9535

(52) U.S. Cl. CPC G06F 21/6245; G06F 16/284; G06F 16/9535

(57) ABSTRACT

An information provision apparatus includes a memory configured to store personal data and a processor coupled to the memory and configured to, in response to reception of a provision request to provide personal data on a data originator create a transaction identifier (ID) based on an identifier of the data originator and a combination of identifiers of holders of personal data on two or more request destinations, associate the personal data stored in the memory with the transaction ID and provide the personal data associated with the transaction ID to an apparatus that uses the personal data.

### CROSS-REFERENCE TO RELATED APPLICATIONS

This application is based upon and claims the benefit of priority of the prior Japanese Patent Application No. 2018-8423, filed on Jan. 22, 2018, the entire contents of which are incorporated herein by reference.

### FIELD

The embodiments discussed herein are related to an apparatus, a program, a method, and a system for providing information.

### BACKGROUND

Demand for a large number of personal data is increasing for market analysis. In the meantime, demand for techniques for reducing unauthorized use of personal data, spoofing, and any other fraud is increasing.

It is known in the art to provide a technique for managing a pair of first and second identifiers (IDs) read at acceptance of an applicant document in a financial institution or the like and an applicant image captured by a surveillance camera at the read timing in association with each other. Examples of the related art are disclosed in Japanese Laid-open Patent Publication No. 2008-009947 and No. 2015-103034.

However, if personal data is associated among different industries, a lot of information may be obtained for a single person. This may enable specification of the person even if the associated personal data contains no information that clearly identifies the person.

In view of the above problem, it is desirable to limit the number of associations of personal data.

### SUMMARY

According to an aspect of the embodiments, an information provision apparatus includes a memory configured to store personal data and a processor coupled to the memory and configured to, in response to reception of a provision request to provide personal data on a data originator create a transaction identifier (ID) based on an identifier of the data originator and a combination of identifiers of holders of personal data on two or more request destinations, associate the personal data stored in the memory with the transaction ID, and provide the personal data associated with the transaction ID to an apparatus that uses the personal data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for illustrating an example of association of history data;

FIG. 2 is a table illustrating data associated using association IDs;

FIG. 3 is a diagram illustrating a configuration example of a system according to an embodiment;

FIG. 4 is a diagram illustrating a hardware configuration;

FIG. 5 is a diagram for illustrating identifiers;

FIG. 6 is a diagram for illustrating a method for creating an identifier 3 according to an embodiment;

FIG. 7 is a diagram for illustrating a process for a purchase request for personal data;

FIG. 8 is a diagram for illustrating checking processing performed by a data holder apparatuses using an identifier 2;

FIG. 9 is a diagram for illustrating provision of personal data;

FIG. 10 is a diagram for illustrating inhibition of an illegal request (Advantageous effect 1);

FIG. 11 is a diagram for illustrating inhibition of unauthorized use (Advantageous effect 2);

FIG. 12 is a diagram for illustrating inhibition of unauthorized use (Advantageous effect 2);

FIG. 13 is a diagram for illustrating examples of the identifier 3 created using a data holder set (r_{A}, r_{B});

FIG. 14 is a diagram for illustrating examples of the identifier 3 created using a data holder set (r_{B}, r_{C});

FIG. 15 is a diagram illustrating an example of the result of association of pseudonym data;

FIG. 16 is a diagram illustrating an example of a personal-data sale screen;

FIG. 17 is a diagram for illustrating a first functional configuration example of the data holder apparatus;

FIG. 18 is a diagram for illustrating the relationship among data in a mediation server;

FIG. 19 is a diagram illustrating a first functional configuration example of the mediation server;

FIG. 20 is a flowchart for illustrating identifier provision processing performed by an identifier providing unit of the data holder apparatus;

FIG. 21 is a flowchart for illustrating correspondence-table creation processing performed by a correspondence-table creation unit of the mediation server;

FIG. 22 is a flowchart for illustrating purchase request processing performed by a purchase-request processing unit of the mediation server;

FIG. 23 is a flowchart for illustrating sale processing performed by a sale processing unit of the data holder apparatus;

FIG. 24 is a flowchart for illustrating temporal-ID creation processing performed by a temporal-ID creation unit;

FIG. 25 is a flowchart for illustrating pseudonym-data transmission processing performed by an pseudonym-data transmission unit;

FIG. 26 is a diagram for illustrating a second functional configuration example of the data holder apparatus;

FIG. 27 is a diagram illustrating a second functional configuration example of the mediation server;

FIG. 28 is a flowchart for illustrating search processing performed by a search unit; and

FIG. 29 is a diagram illustrating a screen example of a search result.

### DESCRIPTION OF EMBODIMENTS

Embodiments of the present disclosure will be described hereinbelow with reference to the drawings. In the embodiments, personal data is “information on an individual” in a wide concept, which is not limited to personal information having information identifying an individual (personal identity). It is expected to create a new value by analyzing personal data created in a plurality of businesses in association with one another. However, not a person who wants to use personal data does not necessarily possess personal data that the person wants to use.

For that reason, the person may purchase the personal data from a data holder possessing the wanted personal data. However, it is not easy to find out what data holders sell what personal data. For that reason, there is a demand for a market for trading personal data.

One example of the personal-data trading market is a market model for mediating the purchaser of personal data and a data holder that sells the personal data. In such a market model, the mediator prepares a data catalog of vendible data, and the data purchaser looks for desired data from the data catalog and purchases the data.

The data catalog, if the data is purchase history data, contains sex, shop name, purchase time, purchase commodity, the number of pieces of personal data, personal-data offering fee, and so on. The data purchaser purchases personal data and associates the personal data for use in analysis.

For example, if it is assumed that history data about personal purchasing (past personal data) and history data on Web browsing (past personal data) each include an e-mail address, which is an identifier that is a value identifying the originator of each data. In this case, using the e-mail address allows association of data having the same e-mail address as data on the identical data originator (hereinafter simply referred to as originator).

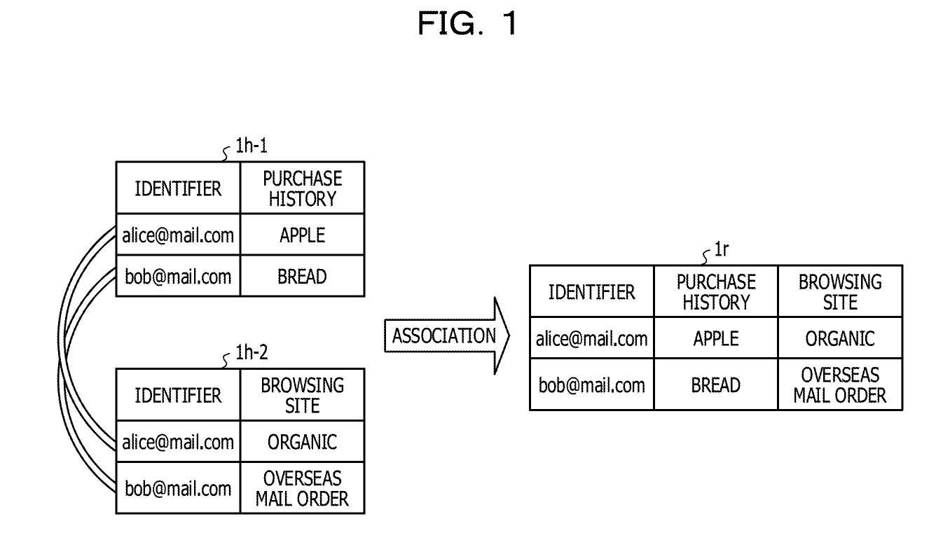

FIG. 1 is a diagram for illustrating an example of association of history data. In FIG. 1, history data 1h-1 and history data 1h-2 each include an e-mail address. The e-mail address is an identifier. The history data 1h-1 includes purchase history in addition to the e-mail address. The history data 1h-2 includes browsing site in addition to the e-mail address.

In the example in FIG. 1, an e-mail address “alice@mail.com” is present in both of the history data 1h-1 and the history data 1h-2, and an e-mail address “bob@mail.com” is present in both of the history data 1h-1 and the history data 1h-2.

Association result 1r is the result of association of data including the same e-mail address. The e-mail address “alice@mail.com” indicates that purchase history “apple” and browsing site “organic” are data on the identical individual. Likewise, the e-mail address “bob@mail.com” indicates that purchase history “bread” and browsing site “overseas mail order” are data on the identical individual.

Thus, in the case where both of the history data 1h-1 and the history data 1h-2 include the same identifier, the two pieces of personal data may be associated even if the history data differ. However, in the case where the same identifier is not present in the history data 1h-1 and the history data 1h-2, the two pieces of personal data may not be associated by identifying the originator of the personal data.

In a personal-data trading market, the data holder has to obtain consent to sell the personal data that the data holder holds to a third party from an individual who is the originator of the personal data. Many originators of personal data feel uneasy about privacy identification whether the originators are identified from the associated personal data.

As in FIG. 1, if the originators of the personal data use real identification data (IDs) like e-mail addresses actually in use, the originators may be identified from the real IDs. For this reason, the personal-data trading market requires a system for protecting privacy so that the originators of personal data are relieved.

An example of the system is privacy protection of the identifier for use in association. Association of personal data requires a common identifier, for example, the name or the e-mail address. However, such real IDs are easy to identify the originators when linking the data.

Depending on the personal data, some originators may think about selling personal data unless IDs are not provided. For that reason, a mediator may issue an association ID to the data seller according to the desire of the originator, and the data holder may replace the identifier in the personal data with the assassination ID and sell the association ID to the data purchaser. Creating the association ID so that the real ID is not presumed disables the data purchaser to obtain the real ID from the association ID.

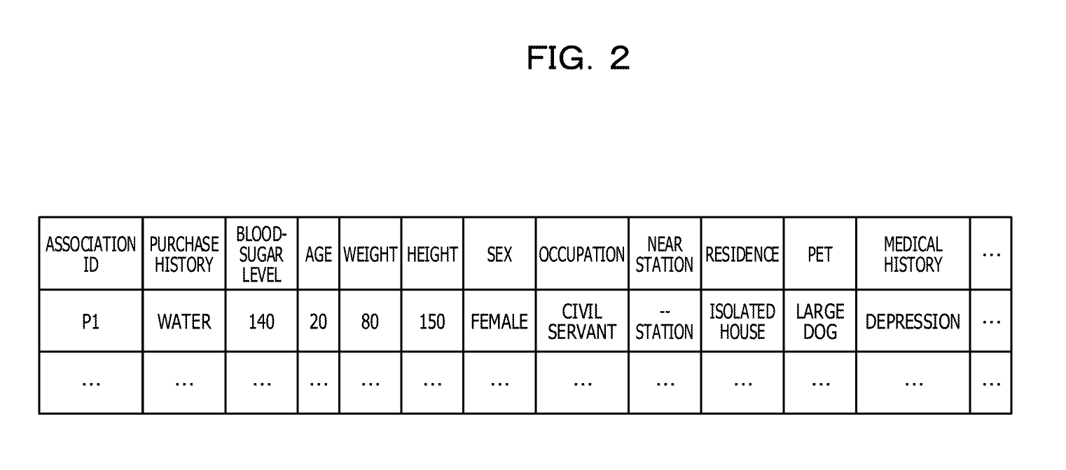

However, even if the real ID is not obtained, obtaining different pieces of personal data from various data holders and associating the personal data may make it easy to identify the individual. FIG. 2 is a table illustrating data associated using the association ID. In the example of data associated using the association ID illustrated in FIG. 2, blood-sugar level, age, weight, height, sex, occupation, near station, residence, pet, medical history, and other values are obtained for the association ID “P1”. The use of such data allows identification of the person.

In one example, 87% of the population of the United States (216 million people/248 million people) may be uniquely identified using a combination of 5 digit zone improvement plan (ZIP) code, sex, and birth date. The ZIP code is used in the United States of America. (Latanya Sweeney. Uniqueness of simple demographics in the US population Technical report, Technical report, Carnegie Mellon University, 2000)

An example in which an individual is identified by linking data is a case in which data on the governor of Massachusetts is identified from medical insurance information and a voter registration list in which names are removed. In this example, the data on the governor in the medical insurance information may be uniquely narrowed by linking ZIP code, sex, and the date of birth included in the two pieces of provided data. (Sweeney Latanya. k-anonymity: A model for protecting privacy, International Journal of Uncertainty, Fuzziness and Knowledge-Based Systems, Vol. 10, No. 05, pp. 557 570, 2002)

The number of associations of personal data may be taken into consideration to cope with privacy issues.

One example measure is setting the maximum number of associations. For example, a mediator transmits the number of associations when transmitting an association ID to a data holder in response to a purchase request from the data purchaser. If the number of associations exceeds the upper limit, the data holder may reject the request. However, if the mediator and the data purchaser conspire with each other to deceive the number of associations, associations exceeding the upper limit may be made. For such conspiracy of the mediator and the data purchaser, a simple countermeasure may not inhibit unauthorized association.

In the present embodiment, a temporary ID is issued for inhibiting unauthorized association exceeding the upper limit even if the mediator and the data purchaser conspire. Data holders each have a data holder ID, and originators each set a condition on the number of associations that may be performed at a time. In the present embodiment, the data holder ID is used in checking the number of associations and creating a temporal ID for association. The temporal ID corresponds to an identifier 3 (to be described later).

The maximum number of personal data to be associated at a time may be set by each data holder or by using another method. After the maximum number set by the originator of the personal data is checked, the set maximum number may be checked by the data holder. In contrast, double check is also possible in which the maximum number is checked by the data holder and then the set maximum number is checked by the originator of the personal data.

This may reduce not only the number of associations according to the desire of the originator of the personal data but also for the data holder to proactively reduce the number of associations in order to inhibit identification of the originator of the personal data.

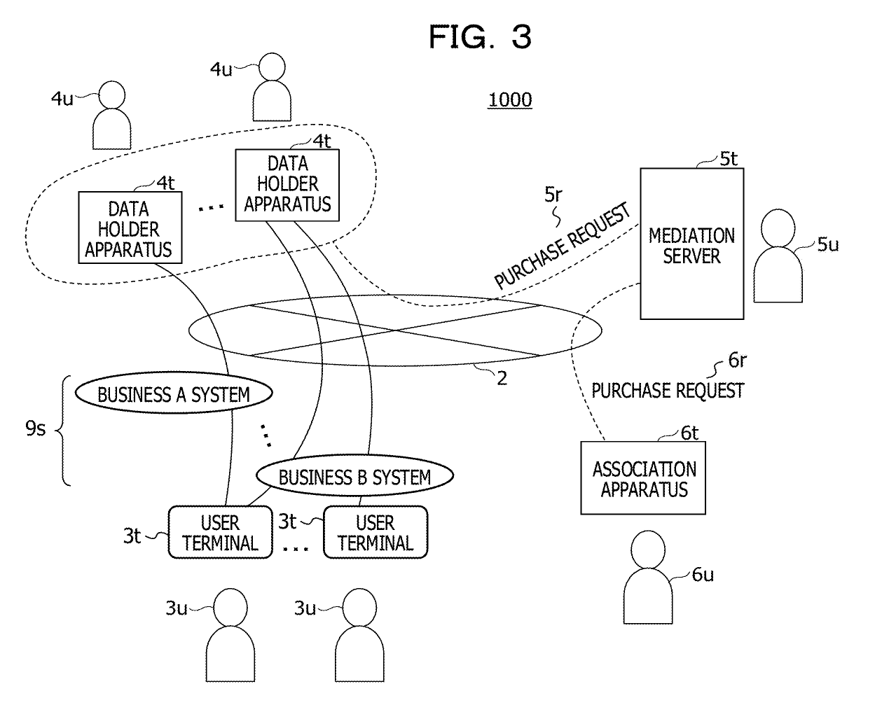

FIG. 3 is a diagram illustrating a configuration example of a system according to the present embodiment. In FIG. 3, the system 1000 includes a plurality of user terminals 3t, a plurality of data holder apparatuses 4t, a mediation server 5t, an association apparatus 6t, and business systems 9s. In the system 1000 in FIG. 1, the plurality of user terminals 3t, the plurality of data holder apparatuses 4t, the mediation server 5t, the association apparatus 6t, and the business system 9s are connected via a network 2.

Each user terminal 3t is a terminal used by an originator 3u, who is a user of the business systems 9s, and is connected to the business systems 9s via the Internet or any other network.

Each data holder apparatus 4t is an apparatus managed by a data holder 4u. The data holder apparatus 4t is an example of an information provision apparatus. A data holder ID is set to each data holder apparatus 4t. Each of the data holder apparatus 4t stores and manages personal data created when each originator 3u uses a corresponding business system 9s.

Each data holder apparatus 4t provides personal data on an originator 3u who accepts sale among the stored personal data to the mediation server 5t in response to a purchase request 5r for personal data from the mediation server 5t. The personal data may be directly provided to the association apparatus 6t of a data purchaser 6u. In this case, the purchase request 5r includes address information on the association apparatus 6t.

The data holder apparatuses 4t are provided in correspondence with the business systems 9s including a business A system and a business B system. If the business A system is a system for online shopping, purchase data on the originator 3u corresponds to personal data. If the business B system is a system for providing a search engine allowing Web information search, search data on web search by the originator 3u corresponds to personal data. In addition, various business systems including a medical system may be connected to the system 1000.

Each business system 9s allows identifying whether the created personal data is data accepted for sale by the originator 3u and stores the data as history data in the data holder apparatus 4t. The personal data created by each business system 9s includes data created when the user terminal 3t is accessed and data created when the originator 3u visits a shop, a medical institution, or any other facility.

The mediation server 5t is an apparatus managed by a mediator 5u. In response to a purchase request 6r from the association apparatus 6t, the mediation server 5t issues the personal-data purchase request 5r to the data holder apparatus 4t of the business system 9s specified by the purchase request 6r. The personal data based on the purchase request 5r may be directly provided to the association apparatus 6t by specifying information on a method for providing the personal data to the data purchaser 6u with the purchase request 6r. The personal data received from the data holder apparatus 4t may be provided to the association apparatus 6t via the mediation server 5t.

The association apparatus 6t is an apparatus that the data purchaser 6u uses. Upon receiving an instruction specifying a business system 9s by the operation of the data purchaser 6u, the association apparatus 6t issues the purchase request 6r specifying the business system 9s to the mediation server 5t. The association apparatus 6t obtains personal data that the business system 9s holds in the data holder apparatus 4t from the mediation server 5t and performs matching (association) of personal data between the businesses for each originator 3u.

In the present embodiment, each data holder apparatus 4t in the system 1000 issues a temporal ID for inhibiting unauthorized association exceeding the maximum number even when the mediator 5u and the data purchaser 6u collude.

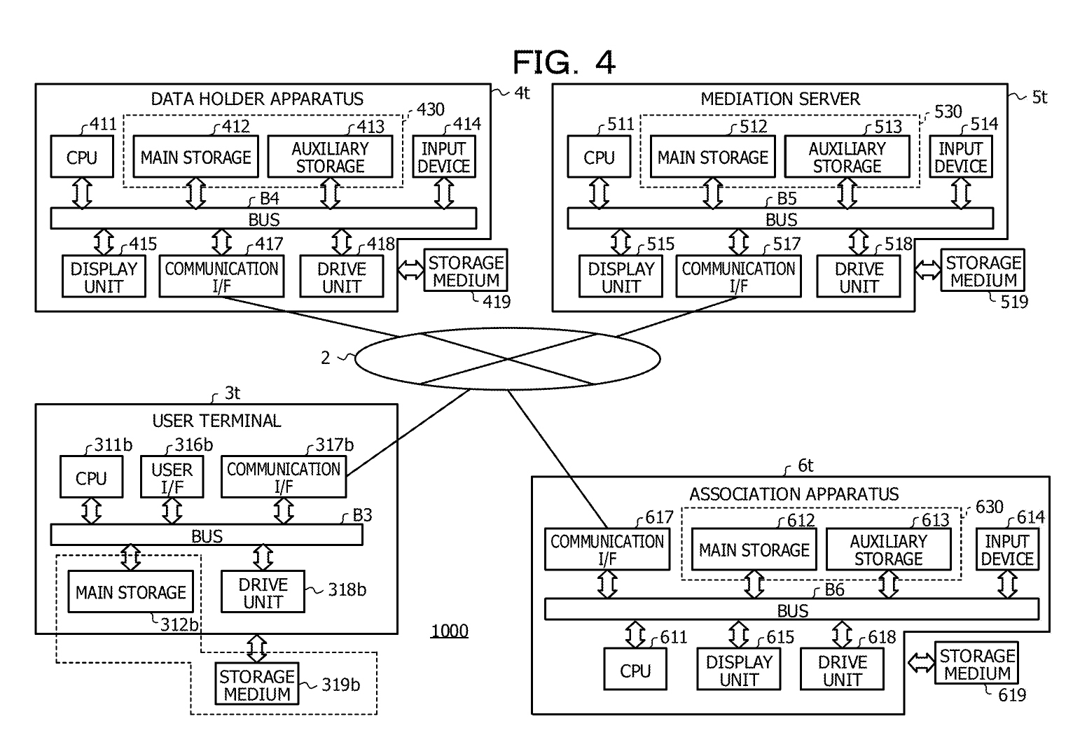

FIG. 4 is a diagram illustrating a hardware configuration. In FIG. 4, the user terminal 3t is an information processing terminal, such as a tablet or a mobile phone, controlled by a computer. The user terminal 3t includes a central processing unit (CPU) 311b, a main storage 312b, a user interface (I/F) 316b, a communication I/F 317b, and a drive unit 318b, which are connected together with a bus B3.

The CPU 311b corresponds to a processor that controls the user terminal 3t according to a program stored in the main storage 312b. The main storage 312b is, for example, a random access memory (RAM) or a read only memory (ROM), and stores or temporarily stores the program to be executed by the CPU 311b, data for use in processing in the CPU 311b, and data obtained by the processing in the CPU 311b. Various processes are implemented when the program stored in the main storage 312b is executed by the CPU 311b.

An example of the user I/F 316b is a touch panel that displays various items of information under the control of the CPU 311b to allow the user to input operations. Communication performed by the communication I/F 317b is not limited to wireless or wired communication.

The program for implementing processing performed by the user terminal 3t is downloaded from an external apparatus via the network 2. Alternatively, the program may be stored in advance in the main storage 312b of the user terminal 3 or a storage medium 319b. The main storage 312b and the storage medium 319b are collectively referred to as a storage unit 330b.

The drive unit 318b interfaces the storage medium 319b (for example, a secure digital (SD) memory card) set in the drive unit 318b and the user terminal 3t with each other. The storage medium 319b may be one or more computer-readable, non-transitory tangible media with a structure.

The user terminal 3t may also be a desktop, notebook, or laptop information processing terminal with a hardware configuration similar to the hardware configuration of the data holder apparatus 4t, described below.

The data holder apparatus 4t is an information processing apparatus controlled by a computer. The data holder apparatus 4t includes a CPU 411, a main storage 412, an auxiliary storage 413, an input device 414, a display unit 415, a communication I/F 417, and a drive unit 418, which are connected together with a bus B4.

The CPU 411 corresponds to a processor that controls the data holder apparatus 4t according to a program stored in the main storage 412. The main storage 412 is, for example, a RAM or a ROM, and stores or temporarily stores the program to be executed by the CPU 411, data for use in processing in the CPU 411, and data obtained by the processing in the CPU 411.

An example of the auxiliary storage 413 is, a hard disk drive (HDD). The auxiliary storage 413 stores data including programs for executing various processes. Various processes are implemented when part of the program stored in the auxiliary storage 413 is loaded on the main storage 412 and executed by the CPU 411. The main storage 412, the auxiliary storage 413, and other accessible external storages are collectively referred to as a storage unit 430.

The input device 414 includes a mouse, a keyboard, and so on and is used for the user to input various pieces of information for use in processing with the data holder apparatus 4t. The display unit 415 displays various items of information under the control of the CPU 411. The input device 414 and the display unit 415 may be an integrated user interface, such as a touch panel. The communication I/F 417 communicates via the wired or wireless network 2. The communication via the communication I/F 417 is not limited to the wired or wireless communication.

The drive unit 418 interfaces a storage medium 419 (for example, a compact disc read-only Memory (CD-ROM)) set in the drive unit 418 and the data holder apparatus 4t with each other.

The programs for implementing processing performed by the data holder apparatus 4t are provided to the data holder apparatus 4t using the storage medium 419, such as a CD-ROM. The storage medium 419 stores programs for implementing various processes according to the present embodiment (to be described later). The programs stored in the storage medium 419 are installed in the data holder apparatus 4t via the drive unit 418. The installed programs become executable by the data holder apparatus 4t.

The storage medium 419 storing the programs is not limited to a CD-ROM but may be one or more computer-readable, non-transitory tangible medium with a structure. The computer-readable storage medium may be a portable recording medium, such as a digital versatile disk (DVD) and a universal serial bus (USB) memory, or a semiconductor memory, such as a flash memory.

The mediation server 5t is an information processing apparatus controlled by a computer and includes a CPU 511, a main storage 512, an auxiliary storage 513, an input device 514, a display unit 515, a communication I/F 517, and a drive unit 518, which are connected via a bus B5. Since the components 511 to 518 of the mediation server 5t are similar to the components of the data holder apparatus 4t, detailed descriptions thereof will be omitted. The main storage 512, the auxiliary storage 513, and other accessible external storages are collectively referred to as a storage unit 530.

The association apparatus 6t is an information processing apparatus controlled by a computer and includes a CPU 611, a main storage 612, an auxiliary storage 613, an input device 614, a display unit 615, a communication I/F 617, and a drive unit 618, which are connected via a bus B6. Since the components 611 to 618 of the mediation server 5t are similar to the components of the data holder apparatus 4t, detailed descriptions thereof will be omitted. The main storage 612, the auxiliary storage 613, and other accessible external storages are collectively referred to as a storage unit 630.

The business systems 9s each include an information terminal including a CPU corresponding to the business, a memory, and so on. Each business system 9s creates personal data when used by the originator 3u and stores the personal data in the data holder apparatus 4t. Since the information terminal has a substantially similar hardware configuration to the hardware configuration of the data holder apparatus 4t, a description thereof will be omitted.

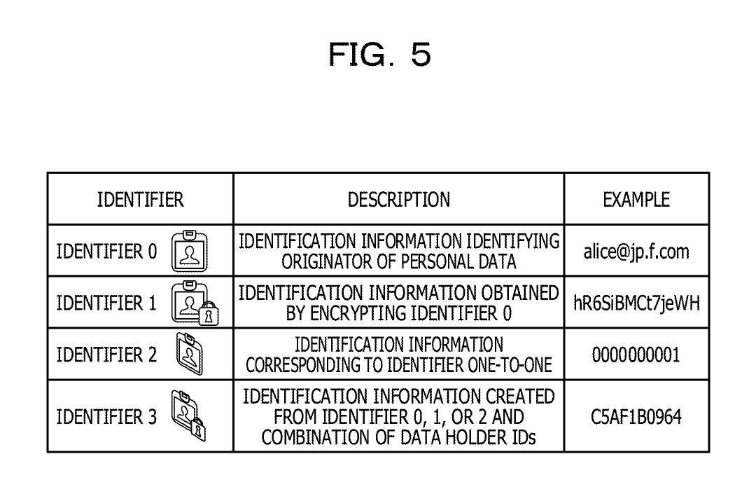

First, the identifiers of the originator 3u that may be used in the present embodiment will be described. FIG. 5 is a diagram for illustrating the identifiers. FIG. 5 illustrates identifiers 0, 1, 2, and 3 associated with the originator 3u.

The identifier 0 is identification information identifying the originator 3u of the personal data. Examples include the name of the originator 3u and a line of communication with the originator 3u, such as an e-mail address. The identifier 1 is identification information obtained by encrypting the identifier 0. The identifier 1 is obtained by encrypting the identifier 0 using a key k set by the originator 3u. The role of the identifier 1 is to inhibit the identifier 0 from being read.

The identifier 2 is identification information corresponding to the identifier 1 one-to-one in a purchase request from the data purchaser 6u. The role of the identifier 2 is to inhibit the personal data from being accumulated in in chronological order and to inhibit diversion for association. By inhibiting time-series accumulation of personal data, personal identification is inhibited. In an operation example, personal identification may be made by obtaining data in which the personal data on a data holder A and the personal data on a data holder B are associated every other month and by linking one year's worth of data.

The identifier 3 is identification information devised by the inventors and corresponds to the temporal ID for association described above. The identifier 3 is identification information created from a combination of one of the identifiers 0, 1, and 2 and the data holder ID using a hash function, such as SHA-256. Preferably, the identifier 3 is created using a keyed hash function using a key set by the originator 3u.

In the example in FIG. 5, in the case where the identifier 0 is “alice@jp.f.com”, the identifier 1 is “hR6SiBMCt7jeWH”, the identifier 2 associated with the identifier 1 is “0000000001”, and the identifier 3 “C5AF1B0964” is created.

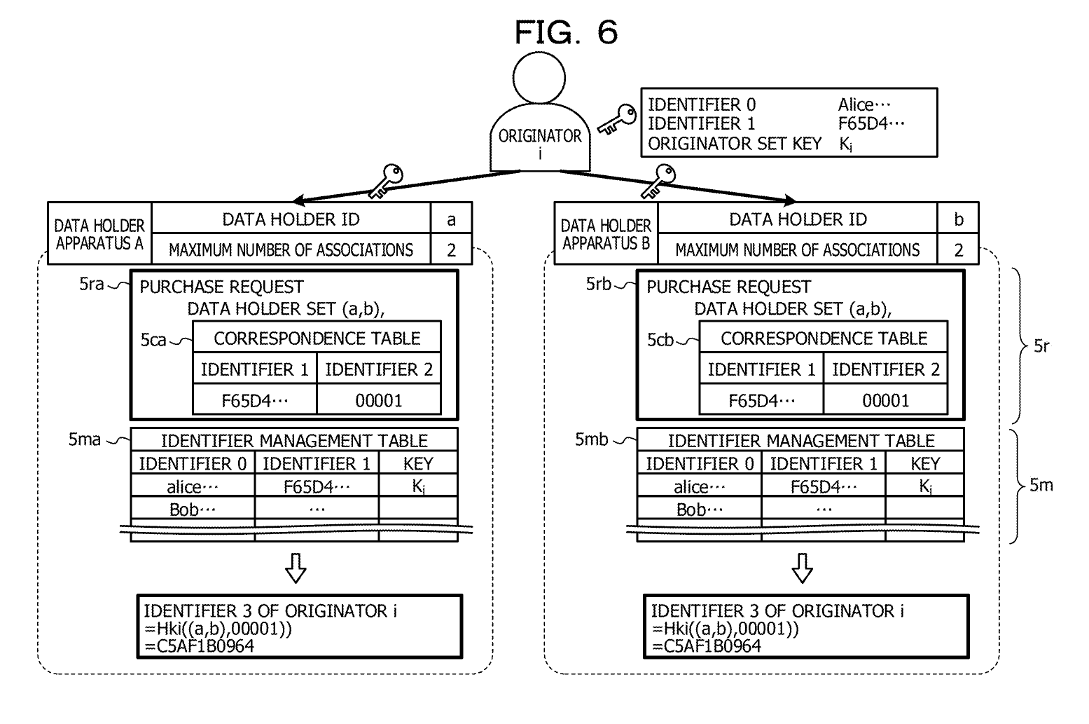

Referring to FIG. 6, a method for creating the identifier 3 will be described. FIG. 6 is a diagram for illustrating a method for creating the identifier 3 according to the present embodiment. In FIG. 6, an originator i provides the identifier 0 to data holder apparatuses A and B and sets an originator set key Ki. The data holder apparatuses A and B encrypt the identifier 0 using the originator set key Ki to obtain the identifier 1. In this example, the data holder apparatuses A and B hold the information,

identifier 0: “Alice . . . ”,

identifier 1: “F65D4 . . . ”, and

originator set key: Ki.

It is assumed that the data holder ID of the data holder apparatus A, is “a”, the maximum number of associations of the data holder ID is “2”, the data holder ID of the data holder apparatus B is “b”, and the maximum number of associations of the data holder apparatus B is “2”.

The data purchaser 6u specifies desired personal data using the identifier 2 and issues the purchase request 6r from the association apparatus 6t to the mediation server 5t. In response to reception of the purchase request 6r from the association apparatus 6t, the mediation server 5t respectively issues a purchase request 5ra to the data holder apparatus A and issues a purchase request 5rb to the data holder apparatus B to sell personal data in the data holder apparatus A and personal data in the data holder apparatus B to the data purchaser 6u based on a stored correspondence tables on the identifier 1 and the identifier 2.

The purchase request 5ra and the purchase request 5rb that are respectively transmitted to the data holder apparatuses A and B include the same data holder set (a, b). The purchase request 5ra may include a correspondence table 5ca in which the identifier 1 and the identifier 2 of the originator i of the personal data managed by the data holder apparatus A are associated. The purchase request 5rb may include a correspondence table 5cb in which the identifier 1 and the identifier 2 of the originator i of the personal data managed by the data holder apparatus B are associated.

In the correspondence tables 5ca and the correspondence table 5cb, the identifier 1 and the identifier 2 may be associated with all identifiers 1 stored in the mediation server 5t. The correspondence table 5ca and the correspondence table 5cb are sometimes collectively referred to as a correspondence table 5c.

Upon receiving the purchase request 5ra, the data holder apparatus A obtains the key Ki associated with the identifier 1 specified on the correspondence table 5ca in the purchase request 5ra with reference to an identifier management table 5ma stored in the data holder apparatus A. The identifier management table 5ma includes the items of identifier 0, identifier 1, and key. In the data holder apparatus A, the identifier 0 or the identifier 1 in the identifier management table 5ma is associated with a database in which personal data is accumulated and stored as history data.

The data holder apparatus A obtains a hash value from a keyed hash function using the data holder set (a, b) specified by the purchase request 5ra and the obtained key Ki. Substituting (a, b) and “00001” of the identifier 2 to the keyed hash function yields a hash value “C5AF1B0964” as the identifier 3 of the originator i.

Changing the identifier 2 for each purchase request inhibits personal identification. For example, diversion for association using the identifier 2 is inhibited so that pieces of personal data separately sold are not associated with each other.

For example, it is assumed that the data purchaser 6u wants to associate data with which personal data held by data holders B and C is associated. The personal data is purchased separately from data with which the personal data of the data holders A and B is associated. Normally, the data purchaser 6u purchase the personal data of the data holder apparatuses A, B, and C at the same time to associate the personal data with one another. However, the data purchaser 6u may reuse data that is purchased and associated before. For that reason, assigning a different identifier 2 for each combination of association data holders inhibits the diversion of association data sold before.

Personal data obtained by replacing the identifier 0 of the originator i with the identifier 3 is provided to the data purchaser 6u.

Although the data holder apparatus B holds an identifier management table 5mb different from the identifier management table 5ma of the data holder apparatus A, the data holder apparatus B performs the same processing as the processing in the data holder apparatus A in response to reception of the purchase request 5rb. The data holder set (a, b) is the same, and the key Ki is also the same. The identifier 3 is “C5AF1B0964” also in the data holder apparatus B. Only for the data holder set, the identifier 3 of the originator i is identical between the data holder apparatuses A and B. The value of the identifier 3 of the originator i differs according to the data holder set.

The identifier management table 5ma and the identifier management table 5mb illustrated in FIG. 6 are collectively referred to as “identifier management table 5m”. The maximum number of associations described above may be set by the data holder apparatus 4t or by the originator i. It is assumed in the following description that the maximum number of associations is “2” for convenience sake.

Personal data in which the identifier 0 of the originator i is replaced with the identifier 3 is provided to the data purchaser 6u.

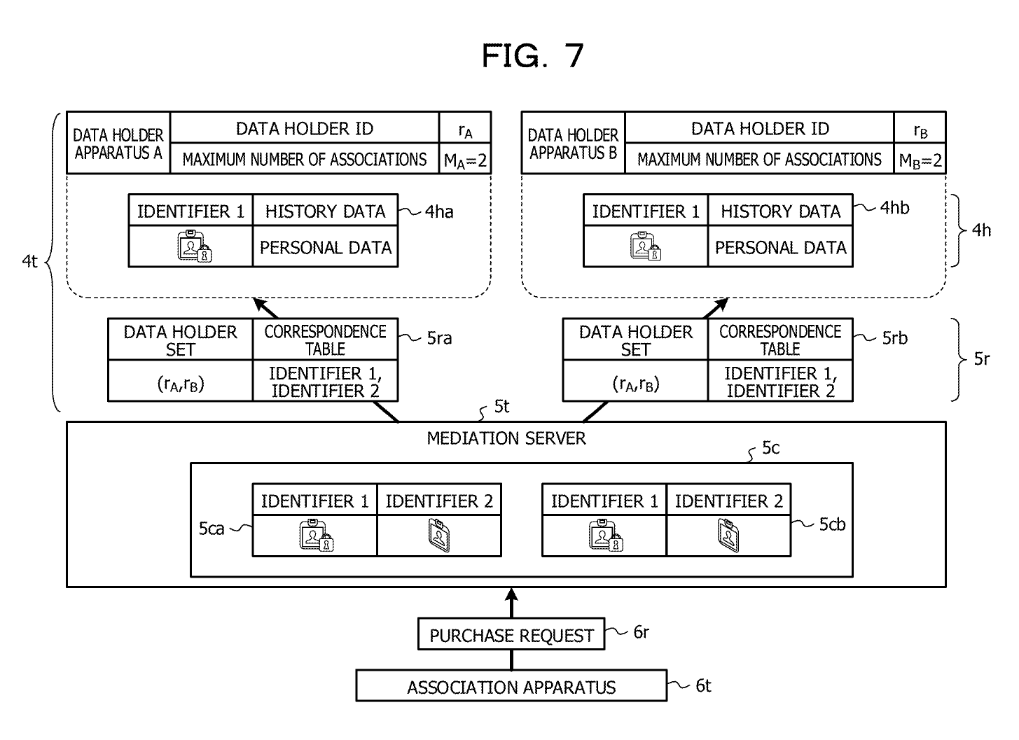

Referring next to FIGS. 7 to 9, a process from issuance of the purchase request 6r for personal data to provision of the personal data will be described in outline. In the following description, the personal data in which the identifier 0 is replaced with the identifier 3 is referred to as “pseudonym data”. Although the present embodiment is applicable to either of the identifier 0 and the identifier 1, the identifier 2 is preferable in order to have the originator 3u provide personal data without anxiety. Therefore, purchase of personal data using the identifier 2 will be described.

FIG. 7 is a diagram for illustrating a process for a purchase request for personal data. In FIG. 7, the data holder apparatus A includes a history data database (DB) 4ha in which personal data is accumulated and managed as history data for each originator 3u. The data holder apparatus B includes a history data DB 4hb in which personal data is accumulated and managed as history data for each originator 3u. The history data DB 4ha and the history data DB 4hb are collectively referred to as “history data DB 4h”.

The purchase request 6r that the mediation server 5t received from the association apparatus 6t specifies two or more data holder IDs. In this example, data holder IDs “r_{A}” and “r_{B}” are specified.

The mediation server 5t creates the purchase request 5r for each data holder apparatus 4t specified by the purchase request 6r and transmits the purchase request 5r to the data holder apparatus 4t. In this example, the mediation server 5t creates a purchase request 5ra specifying a combination of data holder IDs (r_{A}, r_{B}) and a correspondence table 5ca of the identifier 1 and the identifier 2 of the originator 3u of the personal data managed by the data holder apparatus A and transmits the purchase request 5ra to the data holder apparatus A.

Likewise, the mediation server 5t creates the purchase request 5rb specifying a combination of data holder IDs (r_{A}, r_{B}) and a correspondence table 5cb of the identifier 1 and the identifier 2 of the originator 3u of the personal data managed by the data holder apparatus B and transmits the purchase request 5rb to the data holder apparatus B. The combination of data holder IDs is hereinafter referred to as “data holder set”.

In a simpler configuration example, the mediation server 5t may provide a correspondence table of the identifiers 1 and the identifiers 2 of all originators 3u to the purchase request 5ra and the purchase request 5rb without differentiating between the data holder apparatuses A and B like the purchase request 5ra and the purchase request 5rb. In this case, the purchase request 5ra and the purchase request 5rb specify the same data holder set and the same correspondence table 5c.

Each data holder apparatus 4t that has received the purchase request 5r performs checking for inhibiting unauthorized use and association exceeding the maximum number using the identifier 2.

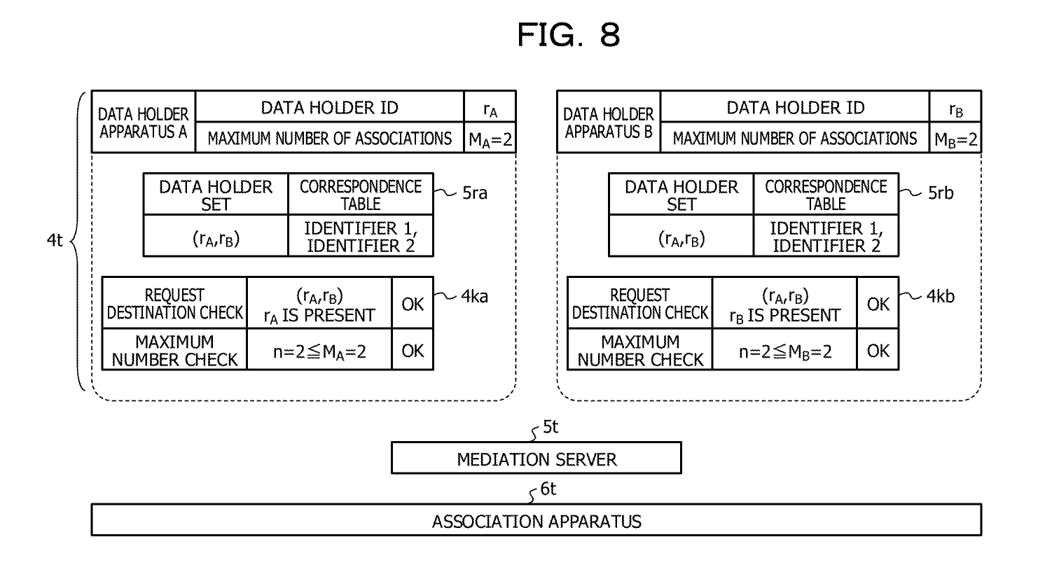

FIG. 8 is a diagram for illustrating the checking process performed by the data holder apparatuses 4t using the identifier 2. In the example of FIG. 8, the maximum number of associations, M_{A}, of the data holder apparatus A is 2, and the maximum number of associations, M_{A}, of the data holder apparatus B is also 2, but this is given for mere illustrative purposes. The originator 3u may set the same maximum number of associations, M, or different maximum numbers of associations, M, between the data holder apparatuses 4t.

The data holder apparatus A performs checking using the data holder set (r_{A}, r_{B}) and the identifier 2 specified by the purchase request 5ra. The checking includes a request destination check for checking the request destination for inhibiting unauthorized use and a maximum number check for inhibiting association exceeding the maximum number.

In the request destination check, it is determined whether the data holder set (r_{A}, r_{B}) includes the data holder ID “r_{A}” of the data holder apparatus A. Since the data holder set (r_{A}, r_{B}) includes the data holder ID “r_{A}”, it is determined that the purchase request 5ra is not a request for unauthorized use.

In the maximum number check, it is determined whether the number of elements n, 2, of the data holder set (r_{A}, r_{B}) is equal to or less than the maximum number of associations, M_{A}, 2. Since the number of elements, n, is equal to or less than the maximum number of associations, M_{A}, it is determined that the request is not a request for association of personal data exceeding the maximum number.

Since the results of the request destination check and the maximum number check are thus affirmative in the data holder apparatus A, as illustrated in a checking result 4ka, the data holder apparatus A provides personal data.

The data holder apparatus B also performs checking and obtains affirmative determination results in the request destination check and the maximum number check, as illustrated in a checking result 4kb. In case of a negative determination result, that is, when at least one condition of the request destination check and the maximum number check is not satisfied, the data holder apparatus A notifies the mediation server 5t of an error and does not provide personal data. Next, provision of personal data using the identifier 3 according to the present embodiment will be described.

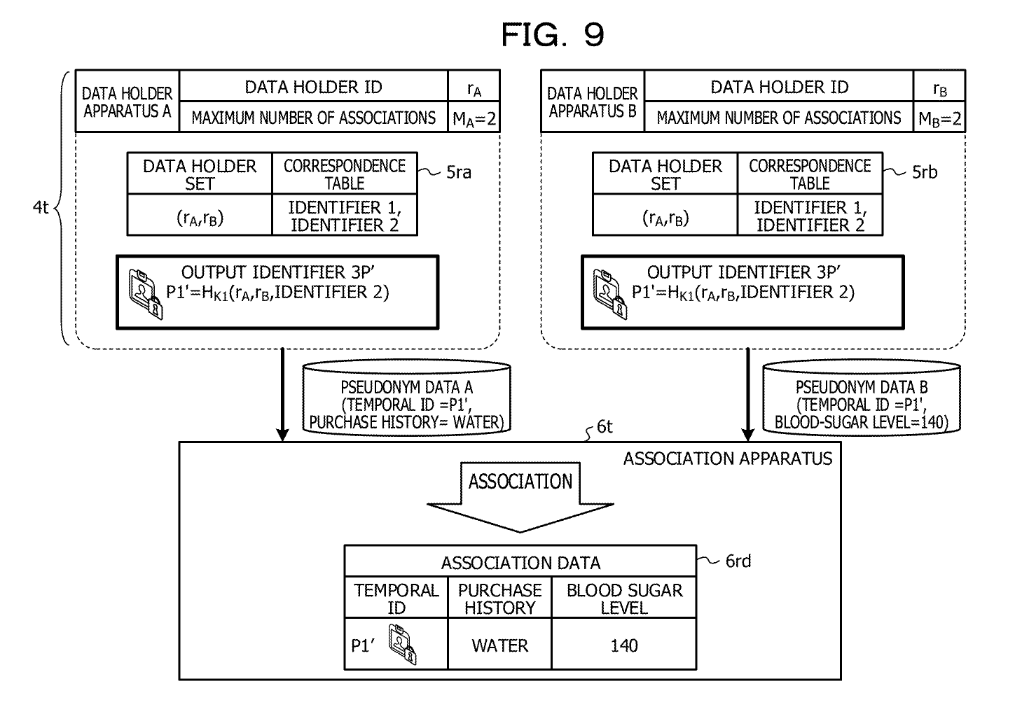

FIG. 9 is a diagram for illustrating provision of personal data. In FIG. 9, each data holder apparatus 4t creates the identifier 3 by obtaining a hash value using the data holder set and the identifier 2. Each data holder apparatus 4t creates pseudonym data obtained by replacing an identifier to be associated with history data with the identifier 3 and provides the created pseudonym data to the association apparatus 6t.

The data holder apparatus A creates the identifier 3 and the pseudonym data A and transmits the created identifier 3 and pseudonym data A to the association apparatus 6t. Likewise, the data holder apparatus B creates the identifier 3 and pseudonym data B and transmits the created identifier 3 and pseudonym data B to the association apparatus 6t. The values of the identifiers 3 created by the data holder apparatus A and the data holder apparatus B are represented by the same value P1′.

The association apparatus 6t associates the received pseudonym data A and pseudonym data B using the identifier 3, which is a temporal ID, to obtain associated data 6rd. The associated data 6rd includes the value P1′ of the identifier 3 as the temporal ID.

In the case where the pseudonym data A includes a temporal ID “P1′” and purchase history “water”, and the pseudonym data B includes a temporal ID “P1′” and blood-sugar level “140”, the association apparatus 6t associates the pseudonym data A and the pseudonym data B using the temporal ID “P1′” to obtain purchase history=“water” and blood-sugar level=“140”.

The present embodiment provides the following advantageous effects by using the identifier 2 and the identifier 3.

Advantageous effect 1: Inhibiting illegal request

An illegal request for illegal association exceeding the maximum number is inhibited.

Advantageous effect 2: Inhibiting unauthorized use

Unauthorized use of an association ID is inhibited by providing pseudonym data using the identifier 3.

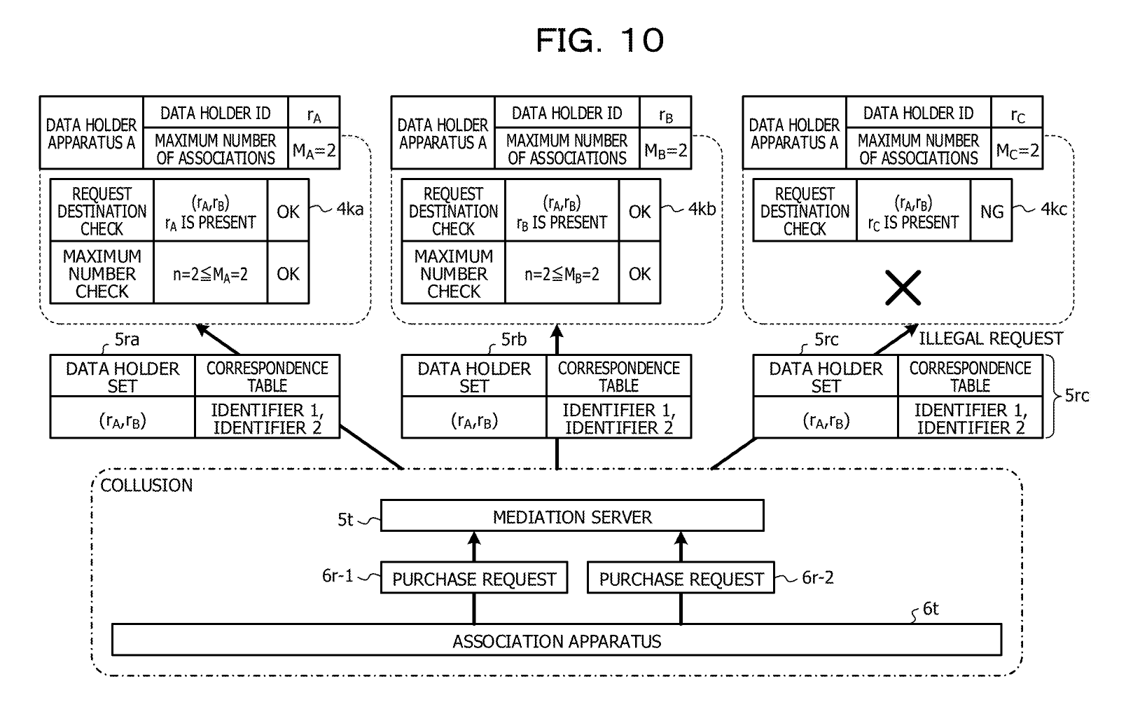

FIG. 10 is a diagram for illustrating inhibition of an illegal request (Advantageous effect 1). FIG. 10 illustrates a data holder apparatus C in addition to the data holder apparatuses A and B. In the data holder apparatuses A, B, and C, the maximum numbers of associations, M_{A} M_{B}, and M_{C}, are the same value “2”.

The mediator 5u and the data purchaser 6r collude to illegally obtain personal data by exceeding the maximum number of associations from the data holder apparatuses A, B, and C. In the example of FIG. 10, first, the mediator 5u and the data purchaser 6r obtain personal data by making a legal request and then make an illegal request using the data holder set in the purchase request issued when the personal data is legally obtained.

First, the data purchaser 6u issues a purchase request 6r-1 in which the personal data of the data holder apparatus A and the personal data of the data holder apparatus B are associated from the association apparatus 6t. In response to the purchase request 6r-1 from the association apparatus 6t, the mediation server 5t transmits a purchase request 5ra and a purchase request 5rb each including the data holder set (r_{A}, r_{B}) and the correspondence table of the identifier 2 and obtains personal data from the data holder apparatuses A and B. The personal data of the data holder apparatus A and the personal data of the data holder apparatus B are respectively provided to the association apparatus 6t as the pseudonym data A and B (FIG. 9).

Next, the data purchaser 6u makes a purchase request 6r-2 in which the personal data of the data holder apparatus B and the personal data of the data holder apparatus C are associated via the association apparatus 6t. In response to the purchase request 6r-2 from the association apparatus 6t, the mediator 5u in collusion with the data purchaser 6u tries to obtain personal data from the data holder apparatus C using the data holder set (r_{A}, r_{B}) in the purchase request 5ra or the purchase request 5rb for which personal data is obtained. The mediation server 5t transmits a purchase request 5rc including the data holder set (r_{A}, r_{B}) and a correspondence table of the identifier 2 to the data holder apparatus C.

The data holder apparatus C performs checking as the data holder apparatuses A and B do as illustrated in FIG. 8. First, a request destination check is performed. In the request destination check, the data holder apparatus C checks whether the data holder set (r_{A}, r_{B}) in the purchase request 5rc includes the data holder ID “r_{C}” of the data holder apparatus C.

In this case, since the data holder set (r_{A}, r_{B}) does not include r_{C}, the data holder apparatus C determines that the request is an illegal request. Thus, the data holder apparatus C obtains a check result 4kc. The data holder apparatus C transmits an error to the mediation server 5t and does not provide personal data.

Thus, even if the illegal purchase request 5rc is transmitted to the data holder apparatus C that is not targeted, the checking in the present embodiment allows the data holder apparatus C to reject the illegal purchase request 5rc because the data holder set (r_{A}, r_{B}) does not include the data holder ID “r_{C}”. Thus, illegal association of personal data due to collusion of the mediator 6u and the data purchaser 5u is inhibited.

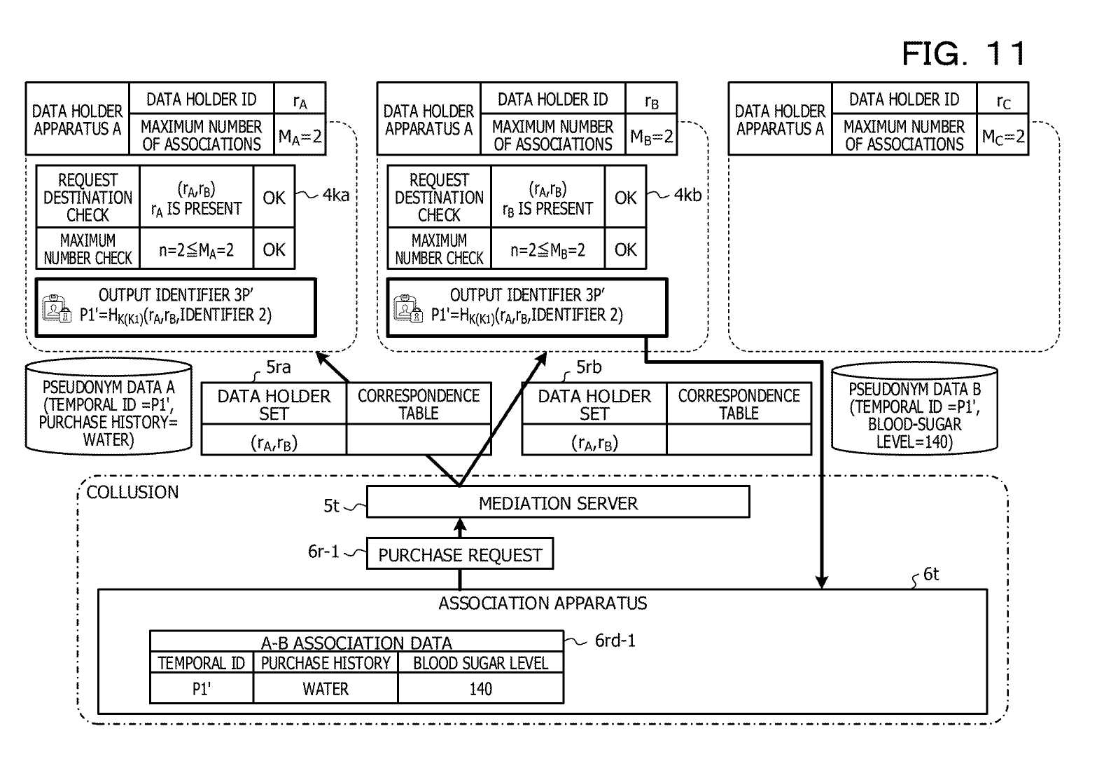

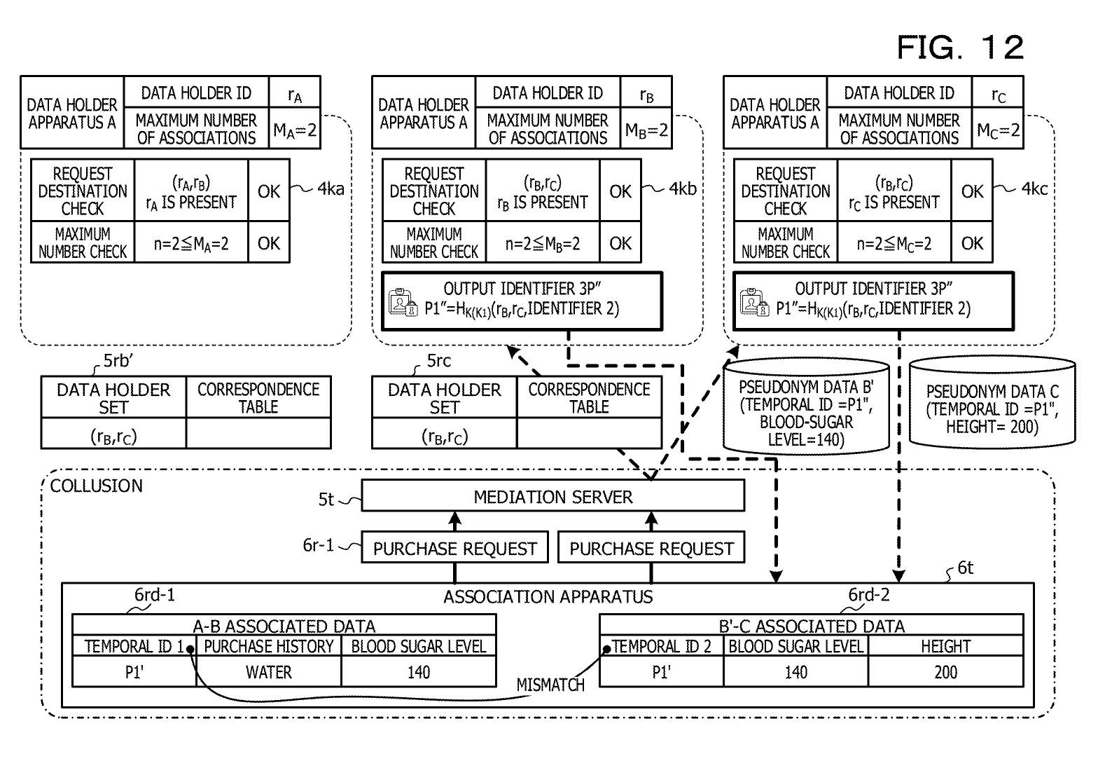

FIGS. 11 and 12 are diagrams for illustrating the inhibition of unauthorized use (Advantageous effect 2). FIGS. 11 and 12 illustrate the data holder apparatus C in addition to the data holder apparatuses A and B. In the data holder apparatuses A, B, and C, the maximum number of associations M_{A}, M_{B}, and M_{C} are the same value “2”.

The mediator 5u and the data purchaser 6r collude to illegally obtain personal data by exceeding the maximum number of associations from the data holder apparatuses A, B, and C. In the example of FIG. 11, first, the mediator 5u and the data purchaser 6r obtain personal data by making a legal request and then make a legal request using a different data holder set and associate the personal data using all the data holder sets.

First, the data purchaser 6u issues a purchase request 6r-1 in which the personal data of the data holder apparatus A and the personal data of the data holder apparatus B are associated from the association apparatus 6t. In response to the purchase request 6r-1 from the association apparatus 6t, the mediation server 5t transmits a purchase request 5ra and a purchase request 5rb each including the data holder set (r_{A}, r_{B}) and the correspondence table of the identifier 2 and obtains personal data from the data holder apparatuses A and B.

The personal data of the data holder apparatus A and the personal data of the data holder apparatus B are respectively provided to the association apparatus 6t as pseudonym data A and pseudonym data B. The identifier in the personal data is replaced with the value P1′ of the identifier 3 which is a temporal ID1. The association apparatus 6t associates the personal data obtained from the data holder apparatuses A and B using the temporal ID1 to obtain A-B associated data 6rd-1.

Next, in FIG. 12, the data purchaser 6u makes a purchase request 6r-3 in which the personal data of the data holder apparatus B and the personal data of the data holder apparatus C are associated via the association apparatus 6t. In response to the purchase request 6r-3 from the association apparatus 6t, the mediator 5u in collusion with the data purchaser 6u tries to obtain personal data from the data holder apparatuses B and C using the data holder set (r_{B}, r_{C}). The mediation server 5t respectively transmits a purchase request 5rb′ and a purchase request 5rc each including the data holder set (r_{B}, r_{C}) and a correspondence table of the identifier 2 to the data holder apparatuses B and C.

The data holder apparatuses B and C each perform checking. In this case, a request destination check and a maximum number check are normally completed in both of the data holder apparatuses B and C.

Since the data holder apparatus B obtains a check result 4kb′ indicating normal end in the request destination check and the maximum number check, the data holder apparatus B obtains the value “P1” of the identifier 3 using the data holder set (r_{B}, r_{C}) and the identifier 2. The data holder apparatus B replaces the identifier in the personal data with the obtained value “P1”” of the identifier 3 into a temporal ID2 to create pseudonym data B′ and transmits the created pseudonym data B′ to the association apparatus 6t. The data holder apparatus C also obtains the value “P1” of the identifier 3 and replaces the identifier in the personal data with the value “P1”” of the identifier 3 into a temporal ID2 to create pseudonym data C and transmits the created pseudonym data C to the association apparatus 6t.

The association apparatus 6t obtains B′-C associated data 6rd-2 using the pseudonym data B′ from the data holder apparatus B and the pseudonym data C from the data holder apparatus C. The association apparatus 6t further tries to associate the A-B associated data 6rd-1 and the B′-C associated data 6rd-2. However, the temporal ID1 of the A-B associated data 6rd-1 and the temporal ID2 of the B′-C associated data 6rd-2 do not match. This inhibits association of the A-B associated data 6rd-1 and the B′-C associated data 6rd-2.

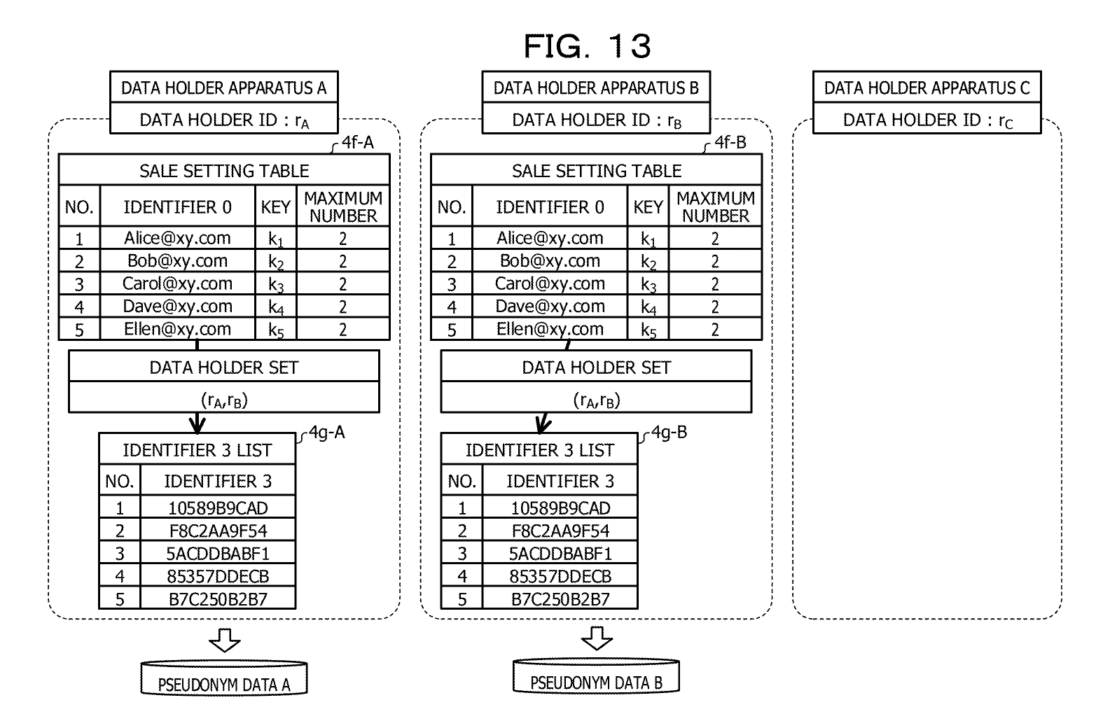

FIGS. 13 to 15 illustrate examples of the identifiers 3 created for a plurality of originators 3u and illustrate examples of the inhibition of unauthorized use (Advantageous effect 2) achieved in the present embodiment. FIGS. 13 to 15 illustrate the data holder apparatuses A, B, and C, as described above. The identifier 0 is an e-mail address, and the personal data on five originators 3u are managed by each of the data holder apparatuses A, B, and C. It is assumed in this example that an affirmative result is obtained in checking.

FIG. 13 is a diagram for illustrating examples of the identifier 3 created using the data holder set (r_{A}, r_{B}). In FIG. 13, the data holder apparatus A holds sale setting information on the sale of personal data, set by each originator 3u, on a sale setting table 4f-A for each originator 3u. The data holder apparatus B also holds sale setting information on the sale of personal data, set by each originator 3u, on a sale setting table 4f-B for each originator 3u.

The data holder apparatus A obtains the key k from the sale setting table 4f-A for each originator 3u. The data holder apparatus A obtains the value of the identifier 3 from a keyed hash function using the obtained key k for the data holder set (r_{A}, r_{B}) and the identifier 2 specified by the purchase request 5ra.

A key k₁ is used for the identifier 0 of Alice@xy.com, a key k₂ is used for the identifier 0 of Bob@xy.com,

a key k₃ is used for the identifier 0 of Carol@xy.com,

a key k₄ is used for the identifier 0 of Dave@xy.com, and

a key k₅ is used for the identifier 0 of “Ellen@xy.com”.

In this example, an identifier 3 with a value “10589B9CAD” is obtained from a keyed hash function using a key k₁ for an originator 3u whose identifier 0 is Alice@xy.com, and an identifier 3 with a value “F8C2AA9F54” is obtained from a keyed hash function using a key k₂ for an originator 3u whose identifier 0 is “Bob@xy.com”. Likewise, an identifier 3 with a value of “F8C2AA9F54” is obtained for an originator 3u whose identifier 0 is “Carol@xy.com”, an identifier 3 with a value of “85357DDECB” is obtained for an originator 3u whose identifier 0 is “Dave@xy.com”, and an identifier 3 with a value of “B7C250B2B7” is obtained for an originator 3u whose identifier 0 is “Ellen@xy.com”.

The thus obtained identifiers 3 are listed on an identifier 3 list 4g-A. The same number in the sale setting table 4f-A and the identifier 3 list 4g-A indicates an identical originator 3u. The data holder apparatus A replaces the identifier that identifies the originator 3u of the personal data using the identifier 3 thus obtained. The identifier that identifies the originator 3u of the personal data corresponds to the identifier 0 and the identifier 1. Although the personal data is not associated with the identifier 0 and the identifier 1, the pseudonym data A given the identifier 3 is transmitted to the association apparatus 6t.

The data holder apparatus B also obtains the value of each identifier 3 from a keyed hash function using the obtained key k for the data holder set (r_{A}, r_{B}) and the identifier 2. The key k for use is the same as the key for the data holder apparatus A.

In this example,

an identifier 3 with a value of “10589B9CAD” is obtained for the identifier 0 of “Alice@xy.com”,

an identifier 3 with a value of “F8C2AA9F54” is obtained for the identifier 0 of “Bob@xy.com”,

an identifier 3 with a value of “F8C2AA9F54” is obtained for the identifier 0 of “Carol@xy.com”,

an identifier 3 with a value of “85357DDECB” is obtained for the identifier 0 of “Dave@xy.com”, and

an identifier 3 with a value of “B7C250B2B7” is obtained for the identifier 0 of “Ellen@xy.com”. The identifiers 3 thus obtained are presented on an identifier 3 list 4g-B.

The data holder apparatus B also replaces the identifier that identifies the originator 3u of the personal data using the identifier 3 thus obtained. Although the personal data is not associated with the identifier 0 and the identifier 1, the pseudonym data B given the identifier 3 is transmitted to the association apparatus 6t.

Since the data holder apparatus A and the data holder apparatus B obtain the same value of the identifier 3 for the same e-mail address, the association apparatus 6t may associate the pseudonym data A and the pseudonym data B with each other.

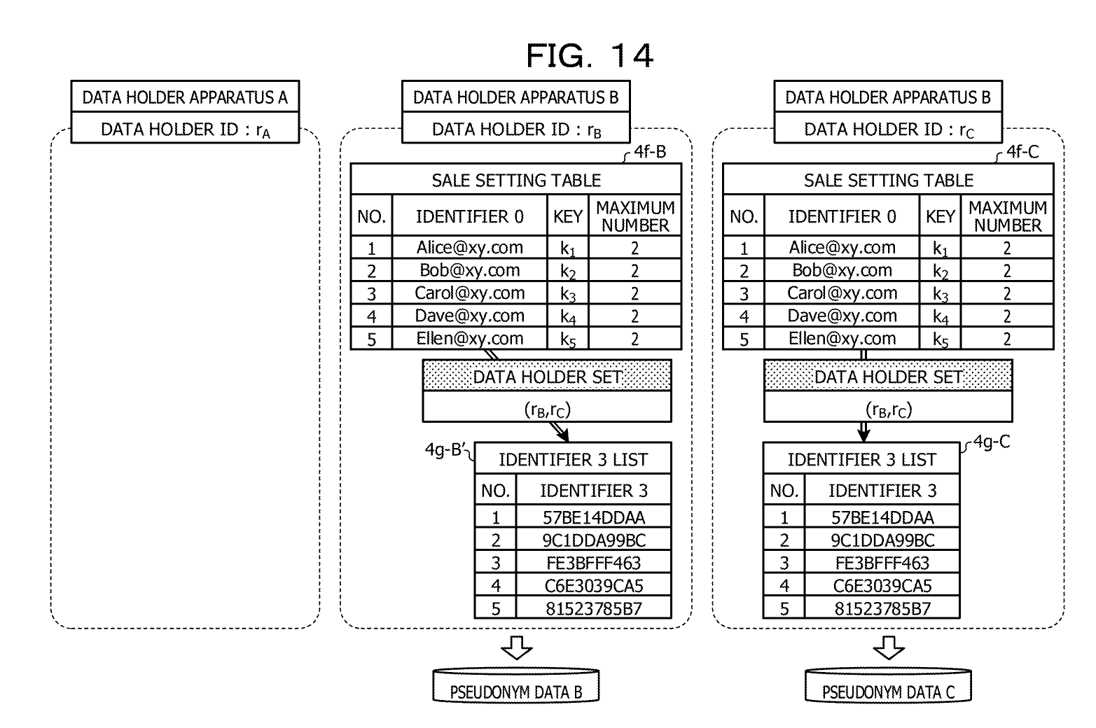

FIG. 14 is a diagram for illustrating examples of the identifier 3 created using the data holder set (r_{B}, r_{C}). In FIG. 14, the data holder apparatus C holds sale setting information on the sale of personal data, set by the originator 3u, on a sale setting table 4f-C for each originator 3u. The data holder apparatus B holds the sale setting information on the sale setting table 4f-B, as illustrated in FIG. 13.

The data holder apparatus B obtains the key k from the sale setting table 4f-B for each originator 3u. The data holder apparatus B obtains the value of the identifier 3 from a keyed hash function using the obtained key k for the data holder set (r_{B}, r_{C}) and the identifier 2 specified by the purchase request 5rb. The key k is the same as in FIG. 13. The data holder set (r_{B}, r_{C}) differs from the data holder set (r_{A}, r_{B}) in FIG. 13.

In this example,

an identifier 3 with a value of “57BE14DDAA” is obtained for the identifier 0 of “Alice@xy.com”,

an identifier 3 with a value of “9C1DDA99BC” is obtained for the identifier 0 of Bob@xy.com,

an identifier 3 with a value of “FE3BFFF463” is obtained for the identifier 0 of “Carol@xy.com”,

an identifier 3 with a value of “C6E3039CA5” is obtained for the identifier 0 of “Dave@xy.com”, and

an identifier 3 with a value of “81523785B7” is obtained for the identifier 0 of “Ellen@xy.com”. The identifiers 3 thus obtained are presented on an identifier 3 list 4g-B′.

Thus, the pseudonym data B′ in which the identifiers in the personal data specifying individuals are replaced with the identifiers 3, that is, only the identifiers 3 are associated, is transmitted to the association apparatus 6t.

The data holder apparatus C also obtains the key k from the sale setting table 4f-C for each originator 3u. The data holder apparatus C obtains the value of the identifier 3 from a keyed hash function using the obtained key k for the data holder set (r_{B}, r_{C}) and the identifier 2 specified by the purchase request 5rb. The obtained identifiers 3 are presented on the identifier 3 list 4g-B′.

The value of the identifier 3 obtained for each identifier 0 is the same as the value of the data holder apparatus B. The pseudonym data C in which the identifiers in the personal data specifying individuals are replaced with the identifiers 3, that is, only the identifiers 3 are associated, is transmitted to the association apparatus 6t.

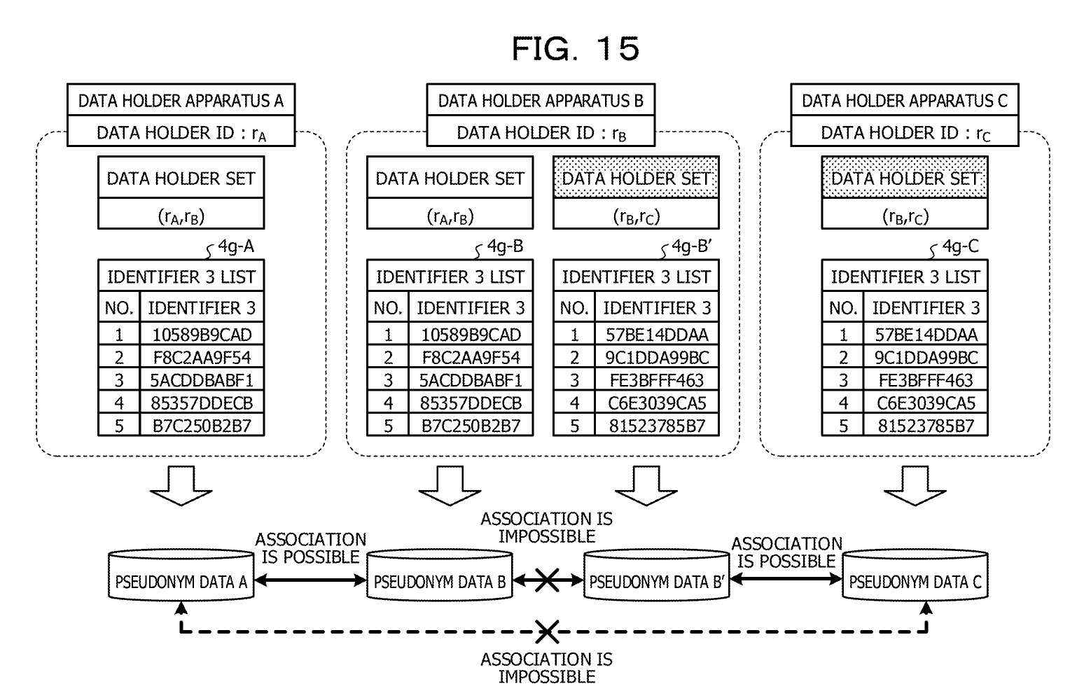

FIG. 15 is a diagram illustrating an example of the result of association of pseudonym data. FIG. 15 illustrates the identifier 3 lists 4g-A, 4g-B, 4g-B′, and 4g-C (hereinafter sometimes collectively referred to as “identifier 3 list 4g”) illustrated in FIGS. 13 and 14. As illustrated in FIG. 13, the values of the same identifiers 3 are presented on the identifier 3 list 4g-A and the identifier 3 list 4g-B. As illustrated in FIG. 14, the same values of the identifiers 3 are presented on the identifier 3 list 4g-B′ and the identifier 3 list 4g-C.

The same number represents the same originator 3u for convenience sake. As apparent from the four identifier 3 lists 4g, the values of the identifiers 3 created for the same originator 3u match between the pseudonym data A and the pseudonym data B. The values of the identifiers 3 created for the same originator 3u are the same between the pseudonym data B′ and the pseudonym data C. This allows association of the pseudonym data A and the pseudonym data B and association of the pseudonym data B′ and the pseudonym data C.

However, even the values of identifiers 3 created for the identical originator 3u differ if the data holder sets in the same data holder apparatus B differ. Therefore, for the identical originator 3u, the values of identifier 3 created using the data holder set (r_{A}, r_{B}) and the values of identifiers 3 created using the data holder set (r_{B}, r_{C}) do not match. This disables association of the pseudonym data B and the pseudonym data B′.

In the data holder apparatus A and the data holder apparatus C, the values of the identifiers 3 created using different data holder sets differ even for the identical originator 3u. This disables association of the pseudonym data A and the pseudonym data C.

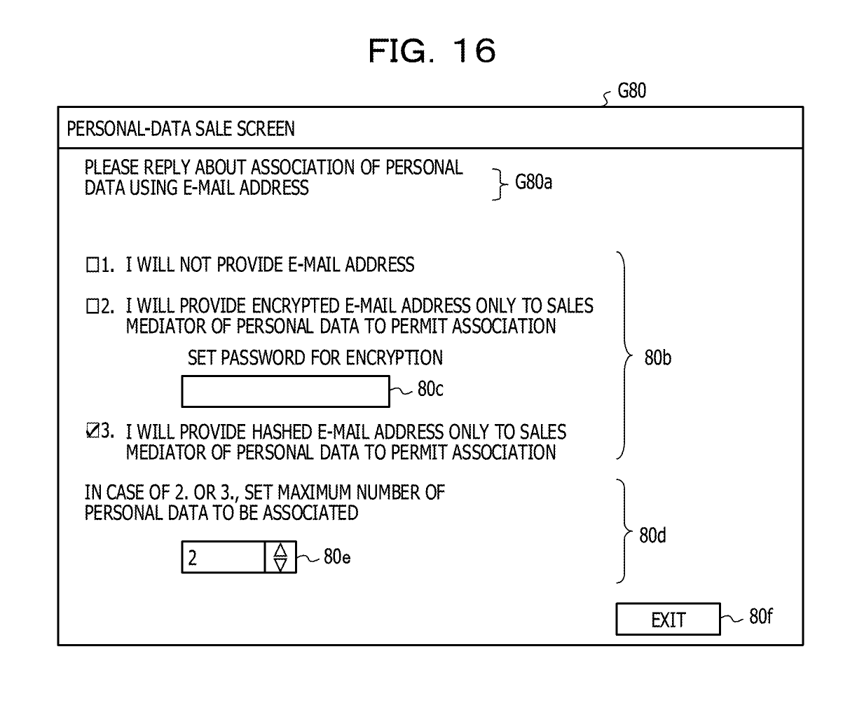

Referring next to FIG. 16, an example of a screen for the sale of personal data on each originator 3u will be described. FIG. 16 is a diagram illustrating an example of a personal-data sale screen. In FIG. 16, a personal-data sale screen G80 is displayed on the user terminal 3t when the originator 3u uses various business systems 9s and is used for the originator 3u to input information. The personal-data sale screen G80 includes a display area 80a, a selection area 80b, a setting area 80d, an exit button 80f, and so on.

The display area 80a is an area to display a message that prompts to reply about association of personal data. In one example, a message “please reply about association of personal data using “e-mail address” is displayed.

The selection area 80b is an area to prompt the originator 3u to selectively reply. Options include “1. I will not provide an e-mail address. 2. I will provide an encrypted e-mail address only to the sales mediator of personal data to permit association. and 3. I will provide a hashed e-mail address only to the sales mediator of personal data to permit association.” The originator 3u selects one of the above options.

When item 2 is selected, any password is input to a password input area 80c by the originator 3u in response to a message “set a password for encryption”.

The setting area 80d is an area to set the maximum number of associations. The setting area 80d displays a message “In the case of 2. or 3., set the maximum number of personal data to be associated”. The originator 3u sets the maximum number in the input area 80e.

The originator 3u who has set required settings presses the exit button 80f. In response to the pressing of the exit button 80f, the information set by the originator 3u is transmitted to the data holder apparatus 4t, and the data holder apparatus 4t stores the received information in the storage unit 430. The password input to the password input area 80c is used in creating the identifier 3. The e-mail address is an e-mail address that is separately registered as personal information and is used as the identifier 0.

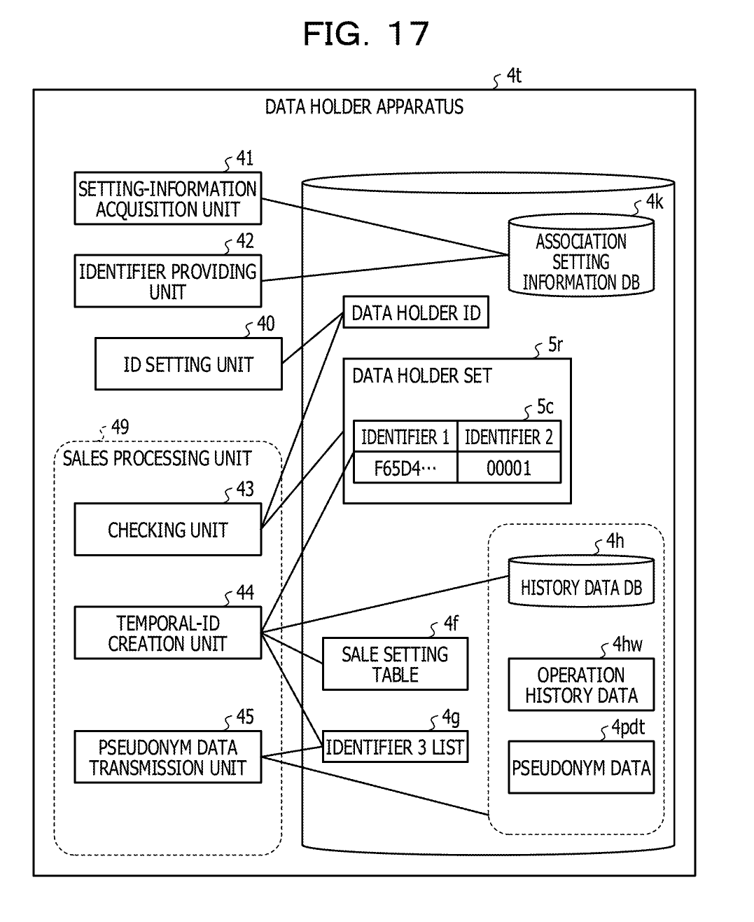

Each of the data holder apparatuses 4t described above has the following functional configuration. FIG. 17 is a diagram for illustrating a first functional configuration example of the data holder apparatus 4t. In FIG. 17, the data holder apparatus 4t includes processing units including an ID setting unit 40, a setting-information acquisition unit 41, an identifier providing unit 42, a checking unit 43, a temporal-ID creation unit 44, and an pseudonym-data transmission unit 45. The processing units 41 to 45 are implemented by processing that the programs installed in the data holder apparatus 4t cause the CPU 411 of the data holder apparatus 4t to execute.

The storage unit 430 stores a data holder ID, the purchase request 5r, the sale setting information table 4f, the identifier 3 list 4g, an association setting information DB 4k, the history data DB 4h, operation history data 4hw, pseudonym data 4pdt, and so on.

The ID setting unit 40 transmits the data holder ID, which is identification information on the data holder apparatus 4t, in the storage unit 430 and transmits the data holder ID to the mediation server 5t. The data holder ID may be set freely and may be changed at regular intervals, but it is preferable to set the data holder ID with paying attention to the following. The purchase request 5r includes a data holder set. Thus may cause a risk that the personal data on the originator 3u is present in another data holder apparatus 4t and that the originator 3u uses another business system 9s are revealed from the data holder ID included in the data holder set in the purchase request 5r.

In one example, it is assumed that the originator 3u does not want the use of a fitness club to be revealed to another data holder apparatus 4t. However, when personal data is sold so as to be associated, the data holder ID of the other data holder apparatus 4t to be associated is obtained from the purchase request 5r at the creation of a temporal ID. If it is revealed that the data holder ID is of the data holder apparatus 4t of the fitness club among the data holder IDs in the data holder set, it may be revealed that all of the originators 3u specified in the correspondence table 5c use the fitness club.

Therefore, it is preferable that the data holder ID is identification information that is not presumed by another data holder apparatus 4t and that does not overlap with other data holder IDs. In one example, the data holder ID is set using random numbers, is changed at regular intervals, and is transmitted to the mediation server 5t every time the change is made. Such setting of the data holder ID allows the data holder ID to protect the privacy of the originator 3u.

The setting-information acquisition unit 41 causes the personal-data sale screen G80 as illustrated in FIG. 16 to be displayed on the user terminal 3t that the originator 3u uses, obtains personal-data setting information from the originator 3u, and stores the personal-data setting information in the association setting information DB 4k in the storage unit 430. The setting-information acquisition unit 41 encrypts the identifier 0 (for example, an e-mail address) using the key of the originator 3u to obtain the identifier 1. The identifier 1 is associated with the identifier 0 and is held in the association setting information DB 4k.

The identifier providing unit 42 provides the identifier 1 managed in the association setting information DB 4k to the mediation server 5t.

The checking unit 43 performs checking using the data holder ID and the data holder set in response to reception of the purchase request 5r from the mediation server 5t. When the checking is normally completed, the checking unit 43 notifies the temporal-ID creation unit 44 of the normal completion. If the checking is not normally completed, the checking unit 43 notifies the mediation server 5t of the error.

The temporal-ID creation unit 44, which is an example of an ID creation unit, obtains a key and the maximum number for each originator 3u from the association setting information DB 4k based on the correspondence table 5c and creates the identifier 3, which is a temporal ID, using the data holder set and the obtained key and maximum number.

The pseudonym-data transmission unit 45, which is an example of a transmission unit, replaces an identifier to be associated with the available personal data on an originator 3u in the history data DB 4h with the identifier 3 to create the pseudonym data 4pdt and transmits the pseudonym data 4pdt to the mediation server 5t. The operation history data 4hw is a table of available personal data of originators 3u extracted from the history data DB 4h. The identifiers 0 and 1 in the operation history data 4hw are replaced with the identifier 3 to create the pseudonym data 4pdt. The pseudonym data 4pdt in which the personal data is associated with the identifier 3 is provided to the mediation server 5t.

The checking unit 43, the temporal-ID creation unit 44, and the pseudonym-data transmission unit 45, described above, correspond to processing units constituting a sale processing unit 49 according to the present embodiment.

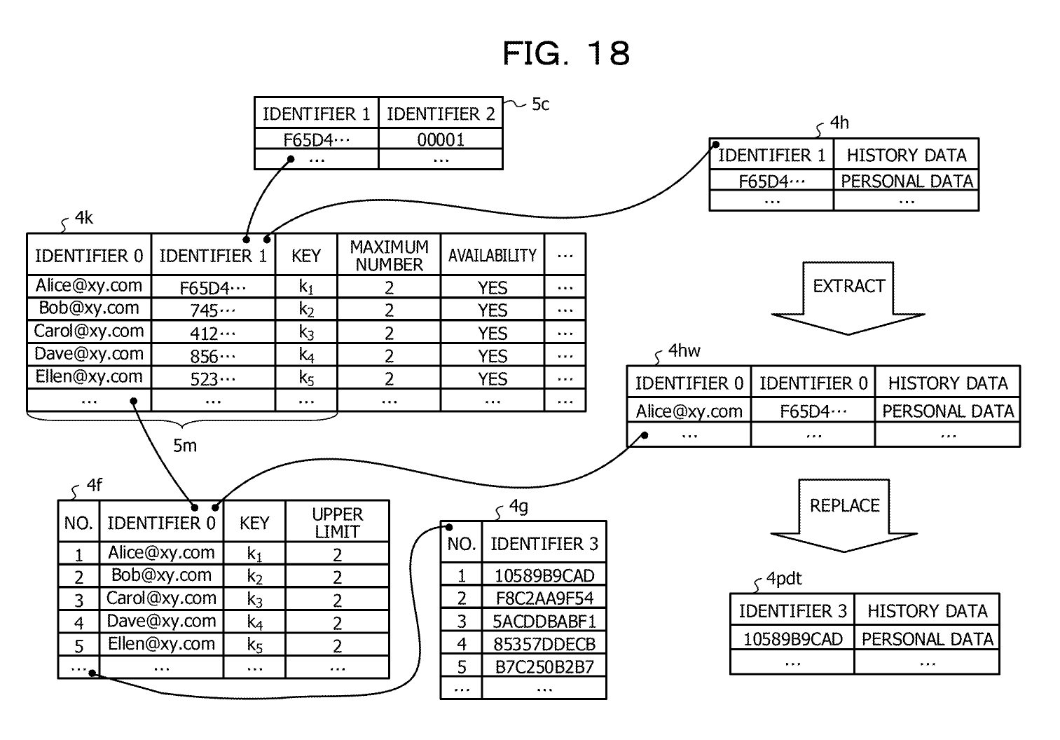

Referring to FIG. 18, association among various pieces of data managed by the mediation server 5t will be described. FIG. 18 is a diagram for illustrating the relationship among data in the mediation server. In the present embodiment, personal data to be sold is specified based on the correspondence table 5c provided from the mediation server 5t to create the pseudonym data 4pdt. The relationship among the data illustrated in FIG. 18 is given for mere illustrative purposes and is not limited thereto.

Referring to FIG. 18, the association setting information DB 4k includes identifier 0, identifier 1, key, maximum number, availability, and other items for each originator 3u. Of the history data DB 4h, the items of identifier 0, identifier 1, and key correspond to the identifier management table 5m.

Identifier 0 is information that specifies the originator 3u, such as an e-mail address. The identifier 1 is data obtained by encrypting the identifier 0 using a key set by the originator 3u. The key is a password that is set by the originator 30u on the personal-data sale screen G80. If the originator 3u specifies that encryption is not required, the key is not set.

The maximum number is the maximum number of purchasers of personal data that may be associate (data holder apparatuses 4t). The maximum number may be set by each data holder apparatus 4t. The availability indicates whether the originator 3u permits selling the personal data. “YES” indicates that the originator 3u permits selling the personal data, and “NO” indicates that the originator 3u does not permit the selling. The availability indicates “YES” when item 2 or 3 is selected on the personal-data sale screen G80, and indicates “NO” when item 1 is selected(to be described later).

The correspondence table 5c is a table in which the identifier 1 and the identifier 2 are associated with each other. The identifier 1 in the correspondence table 5c includes the identifier 1 that the data holder apparatus 4t provides to the mediation server 5t, that is, the identifier 1 present in the association setting information DB 4k.

The history data DB 4h is a database in which the personal data on the originator 3u is accumulated and managed for each identifier 1. The identifier 1 may be present in duplicate. The identifier 1 in the history data DB 4h is an identifier 1 present in the association setting information DB 4k. The use of the identifier 1 allows obtaining an identifier 0 associated with the personal data in the history data DB 4h.

The sale setting information table 4f includes records extracted from the association setting information DB 4k based on the correspondence table 5c and includes number, identifier 0, key, maximum number, and other items. In this example, the maximum number is “2”. In another example in which the data holder set includes three data holder IDs, records in which the maximum number is three or more are extracted from the records in the association setting information DB 4k to create the sale setting information table 4f. The identifier 0 in the sale setting information table 4f is the identifier 0 in the history data DB 4h.

The identifier 3 list 4g is a list of the identifiers 3, which is a temporal ID, obtained by calculating a hash value using the holder data set and the identifier 2 in the purchase request 5r from the records in the sale setting information table 4f. If the records are keyed, the hash value is preferably calculated from a keyed hash function. Each record in the identifier 3 list 4g specifies a record in the sale setting information table 4f using the number.

The operation history data 4hw is a table created by obtaining the identifier 0 from the association setting information DB 4k using the identifier 1 of each record in the history data DB and adding the obtained identifier 0 to the record in the history data DB.

The pseudonym data 4pdt is data created by replacing the identifier 0 and the identifier 1 in the operation history data 4hw with the identifier 3 and includes the items of the identifier 3 and history data. By obtaining the record number in the sale setting information table 4f using the identifier 0 in the operation history data 4hw, the identifier 3 is obtained from the identifier 3 list 4g. The identifier 0 and the identifier 1 in the operation history data 4hw may be replaced with the obtained identifier 3.

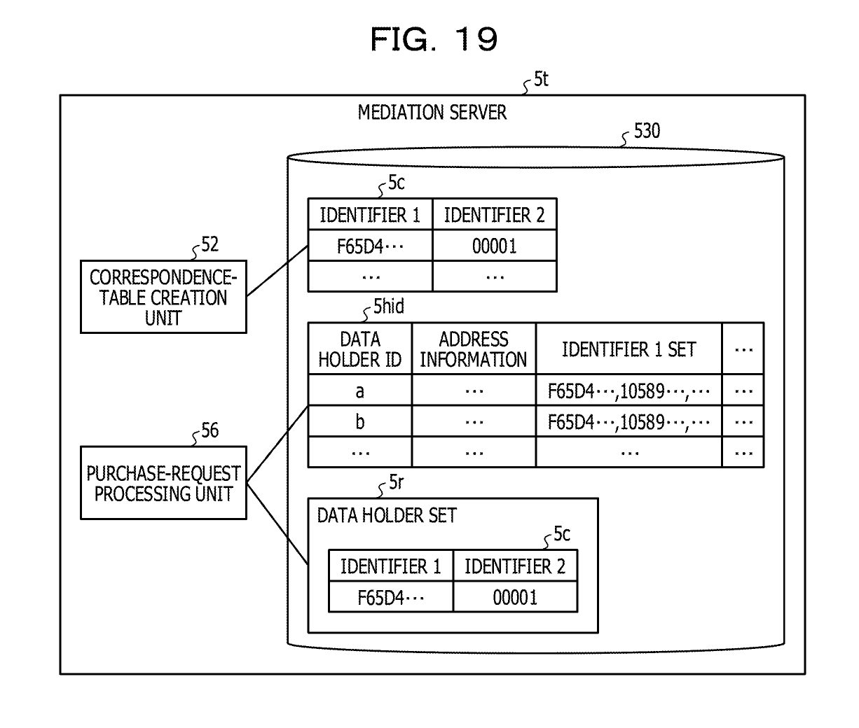

FIG. 19 is a diagram illustrating a first functional configuration example of the mediation server 5t. In FIG. 19, the mediation server 5t includes processing units including a correspondence-table creation unit 52 and a purchase-request processing unit 56. The correspondence-table creation unit 52 and the purchase-request processing unit 56 are implemented by processing that programs installed in the mediation server 5t cause the CPU 511 of the mediation server 5t to execute.

The storage unit 530 stores the correspondence table 5c, a data holder information table 5hid, the purchase request 5r, and so on.

Upon receiving the purchase request 6r from the association apparatus 6t, the correspondence-table creation unit 52 creates identifiers 2 corresponding to the identifiers 1 in the data holder apparatus 4t one-to-one to create the correspondence table 5c. One correspondence table 5c may be created for all the data holder apparatus 4t. However, the correspondence table 5c may be created for each data holder apparatus 4t in consideration of a case in which the identifier 1 differs among the data holder apparatuses 4t.

The purchase-request processing unit 56 creates a purchase request 5r for the two or more data holder apparatuses 4t in response to the purchase request 6r from the association apparatus 6t and transmits the purchase request 5r to each of the data holder apparatuses 4t. The purchase request 6r includes a data holder set and the correspondence table 5c.

The data-holder information table 5hid is a table that stores and manages registered information of the data holder apparatus 4t and includes data holder ID, address information, identifier 1 set, and any other items. The data holder ID is identification information specified by the data holder apparatus 4t. The address information is, for example, the IP address of the data holder apparatus 4t, and is referred to at communication with the data holder apparatus 4t. The identifier 1 set is a set of the identifiers 1 of data originators 3u that may be provided by the data holder apparatus 4t and is referred to when the correspondence-table creation unit 52 creates the correspondence table 5c.

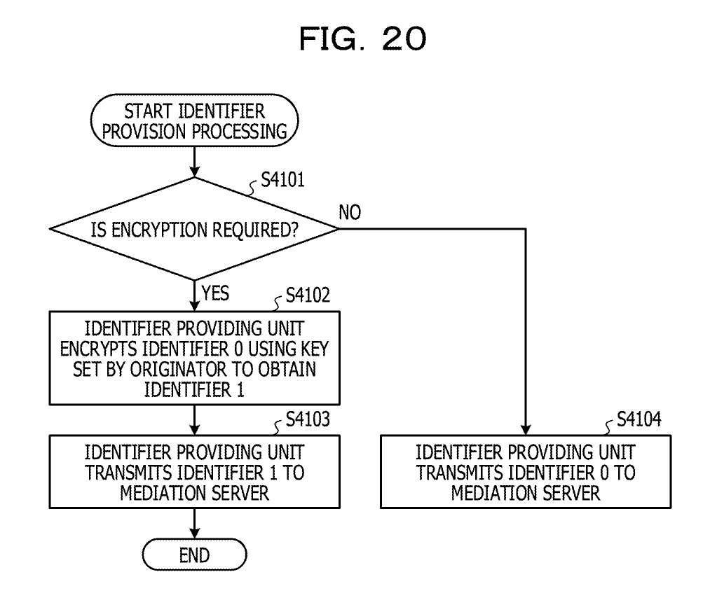

Next, various processes according to the present embodiment will be described using flowcharts. FIG. 20 is a flowchart for illustrating identifier provision processing performed by the identifier providing unit 42 of the data holder apparatus 4t. In the data holder apparatus 4t, the identifier providing unit 42 selects one record from the association setting information DB 4k and performs steps S4101 to S4104.

Referring to FIG. 20, the identifier providing unit 42 determines whether the identifier 0 of the originator 3u has to be encrypted (step S4101). In this case, the identifier providing unit 42 may determine whether a key is set to the record selected from the association setting information DB 4k.

If the identifier 0 has to be encrypted (step S4101: YES), the identifier providing unit 42 encrypts the identifier 0 using the key set by the originator 3u to obtain the identifier 1 (step S1402). The identifier providing unit 42 transmits the identifier 1 to the mediation server 5t (step S1403) and terminates the identifier provision processing.

In contrast, if encryption is not required (step S4101: NO), the identifier providing unit 42 transmits the identifier 0 to the mediation server 5t (step S1404) and terminates the identifier provision processing.

The identifier providing unit 42 performs the identifier provision processing on all records in the association setting information DB 4k. In the above description, the identifier 1 or the identifier 0 is transmitted to the mediation server 5t for each selected record. In some embodiments, the identifier 1 or the identifier 0 may be collectively transmitted to the mediation server 5t after being determined for all the records.

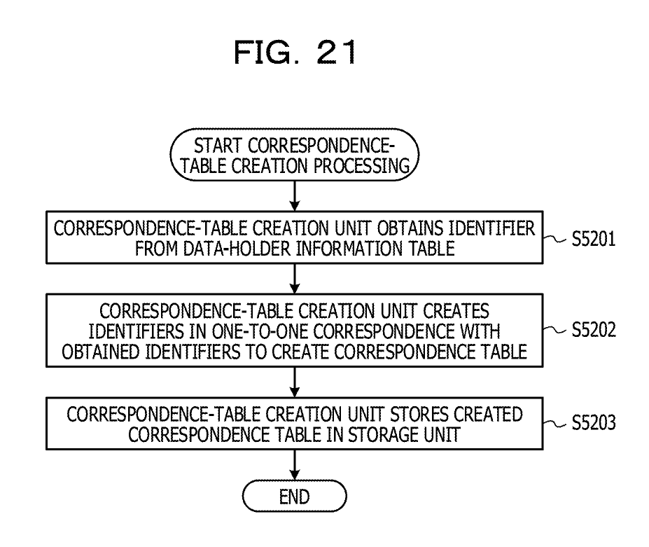

FIG. 21 is a flowchart for illustrating correspondence-table creation processing performed by the correspondence-table creation unit 52 of the mediation server 5t. In FIG. 21, the correspondence-table creation unit 52 obtains an identifier (the identifier 1 or the identifier 0) from the data-holder information table 5hid (step S5201).

The correspondence-table creation unit 52 creates identifiers 2 in one-to-one correspondence with the obtained identifiers 1 or 0 to create the correspondence table 5c (step S5202) and stores the created correspondence table 5c in the storage unit 530 (step S5203). The correspondence-table creation unit 52 terminates the correspondence-table creation processing.

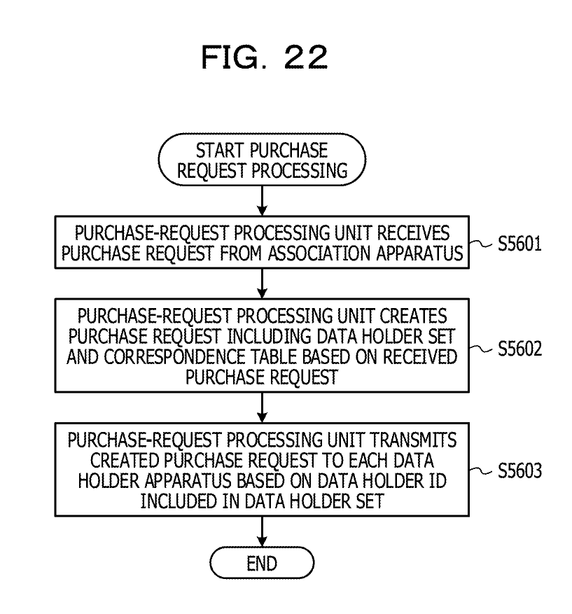

FIG. 22 is a flowchart for illustrating purchase request processing performed by the purchase-request processing unit 56 of the mediation server 5t. In FIG. 22, the purchase-request processing unit 56 receives the purchase request 6r from the association apparatus 6t (step S5601).

The purchase-request processing unit 56 creates a purchase request 5r including a data holder set and a correspondence table 5r based on the received purchase request 6r for each data holder apparatus 4t specified by the data holder set (step S5602).

The purchase-request processing unit 56 transmits the created purchase request 5r to each data holder apparatus 4t based on the data holder ID included in the data holder set (step S5603). The purchase-request processing unit 56 obtains address information of each data holder apparatus 4t by referring to the data-holder information table 5hid using the data holder ID and transmits the purchase request 5r to the data holder apparatus 4t. Thereafter, the purchase-request processing unit 56 terminates the purchase request processing.

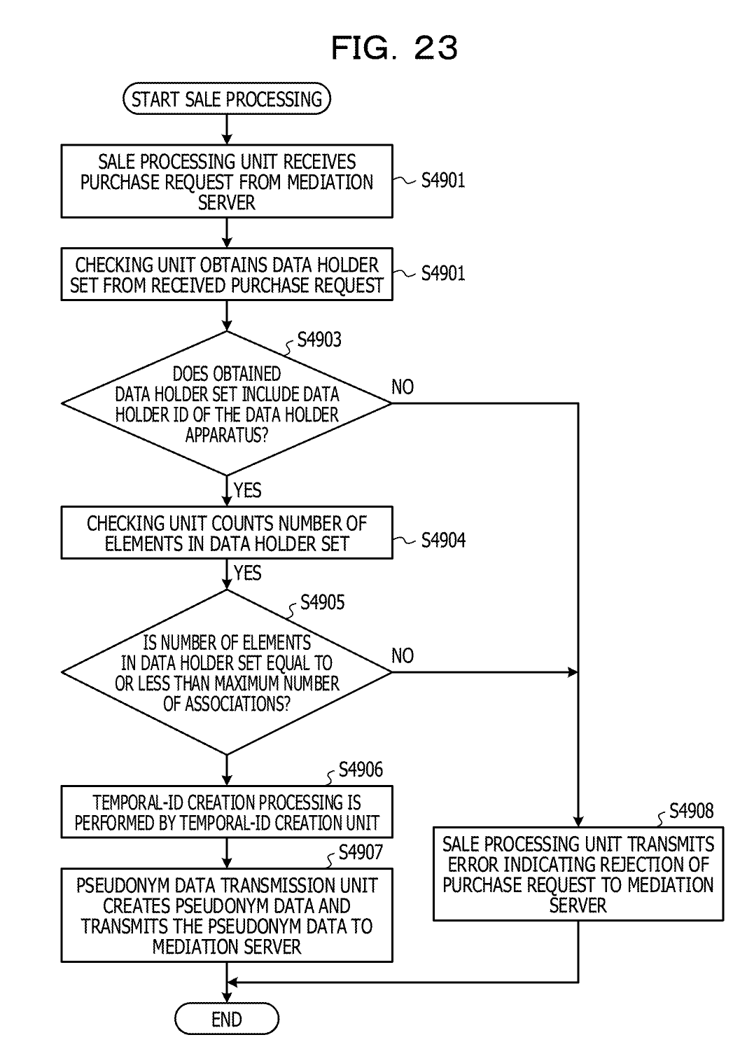

FIG. 23 is a flowchart for illustrating sale processing performed by the sale processing unit 49 of the data holder apparatus 4t. In FIG. 23, the sale processing unit 49 receives a purchase request 5r from the mediation server 5t via the network 2 (step S4901).

In the sale processing unit 49, the checking unit 43 obtains a data holder set from the received purchase request 5r (step S4902) and determines whether the obtained data holder set includes the data holder ID of the data holder apparatus 4t (step S4903).

If the obtained data holder set includes the data holder ID of the data holder apparatus 4t (step S4903: YES), the request destination check performed by the checking unit 43 ends successfully, and the checking unit 43 counts the number of elements in the data holder set (step S4904).

The checking unit 43 determines whether the number of elements in the data holder set is equal to or less than the maximum number of associations (step S4905). The checking unit 43 determines whether the maximum number is less than the number of elements of the data holder set for all the identifiers 1 specified in the correspondence table 5c with reference to the association setting information DB 4k. If the number of elements of the data holder set is greater than the maximum number of associations for all the identifiers 1 specified in the correspondence table 5c, the determination is NO.

If the number of elements of the data holder set is equal to or less than the maximum number of associations (step S4905: YES), the maximum number check performed by the checking unit 43 is normally completed. For example, if the number of elements of the data holder set of at least one of the identifiers 1 specified in the correspondence table 5c in the association setting information DB 4k is equal to or less than the maximum number of associations, the maximum number check is normally completed.

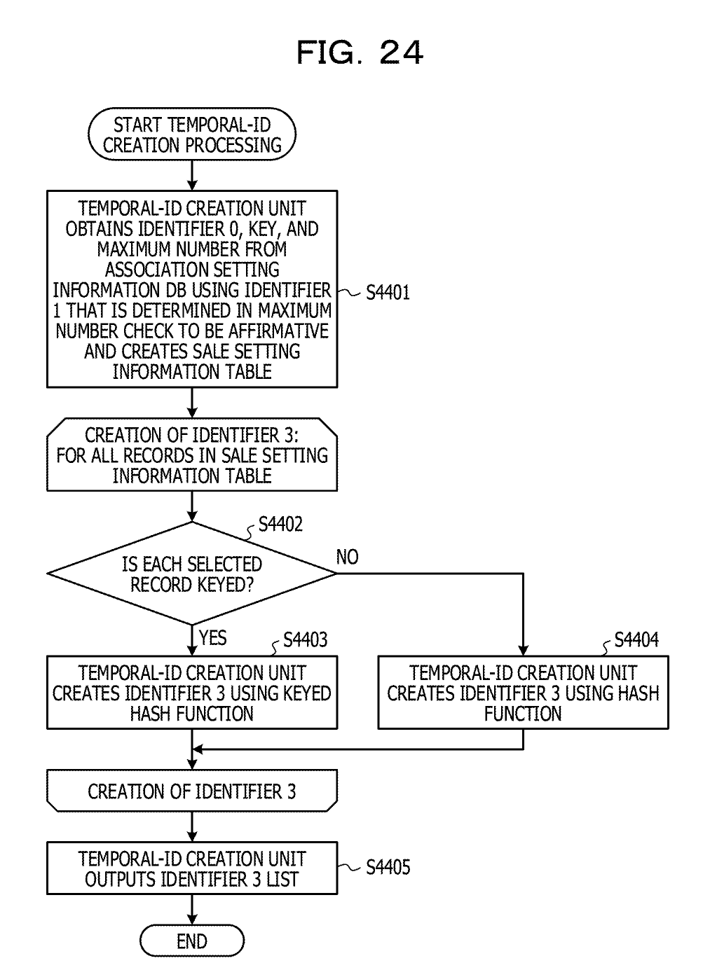

When the checking performed by the checking unit 43 ends normally, temporal-ID creation processing is performed by the temporal-ID creation unit 44 (step S4906). The temporal-ID creation processing will be described in detail in FIG. 24. By the temporal-ID creation processing, the operation history data 4hw, the sale setting information table 4f, and the identifier 3 list 4g are created in the storage unit 430.

In response to the end of the temporal-ID creation processing, the pseudonym-data transmission unit 45 creates the pseudonym data 4pdt and transmits the pseudonym data 4pdt to the mediation server 5t (step S4907). The pseudonym-data transmission unit 45 replaces the identifier 0 and the identifier 1 in the operation history data 4hw with the identifier 3 with reference to the sale setting information table 4f and the identifier 3 list 4g to create the pseudonym data 4pdt in the storage unit 430. The pseudonym-data transmission unit 45 transmits the created pseudonym data 4pdt to the association apparatus 6t.

If the data holder set does not include the data holder ID of the data holder apparatus 4t (step S4903: NO), the sale processing unit 49 transmits an error indicating rejection of the purchase request 5r to the mediation server 5t (step S4908) and terminates the purchase request processing.

Also when the number of elements in the data holder set is greater than the maximum number of associations (step S4905: NO), the sale processing unit 49 transmits an error indicating rejection of the purchase request 5r to the mediation server 5t (step S4908), and the purchase request processing is terminated.

FIG. 24 is a flowchart for illustrating temporal-ID creation processing performed by the temporal-ID creation unit 44. In FIG. 24, the temporal-ID creation unit 44 obtains the identifier 0, key, and the maximum number from the association setting information DB 4k using an identifier 1 that is determined in the maximum number check to be affirmative (step S4905: YES) and creates the sale setting information table 4f (step S4401).

The temporal-ID creation unit 44 performs steps S4402 to S4404 for creating the identifier 3 for all the records in the sale setting information table 4f. The temporal-ID creation unit 44 selects the records one by one from the sale setting information table 4f.

The temporal-ID creation unit 44 determines whether a key is set for each selected record (step S4402). If the selected record is keyed (step S4402: YES), the temporal-ID creation unit 44 obtains the key from the record and creates the identifier 3 using a keyed hash function using the obtained key, the data holder set in the purchase request 5r, and the identifier 2 (step S4403).

In contrast, if the selected record is not keyed (step S4402: NO), the temporal-ID creation unit 44 creates the identifier 3 using a hash function using the data holder set in the purchase request 5r and the identifier 2 (step S4404).

The identifier 2 for use in creating the identifier 3 may be obtained in such a manner that an identifier 1 corresponding to the identifier 0 of the selected record is obtained from the association setting information DB 4k and an identifier 2 corresponding to the obtained identifier 1 is obtained from the correspondence table 5c.

After the identifier 2 is created for all the records in the sale setting information table 4f, the temporal-ID creation unit 44 outputs the identifier 3 list 4g to the storage unit 430 (step S4405), and the temporal-ID creation processing is terminated.

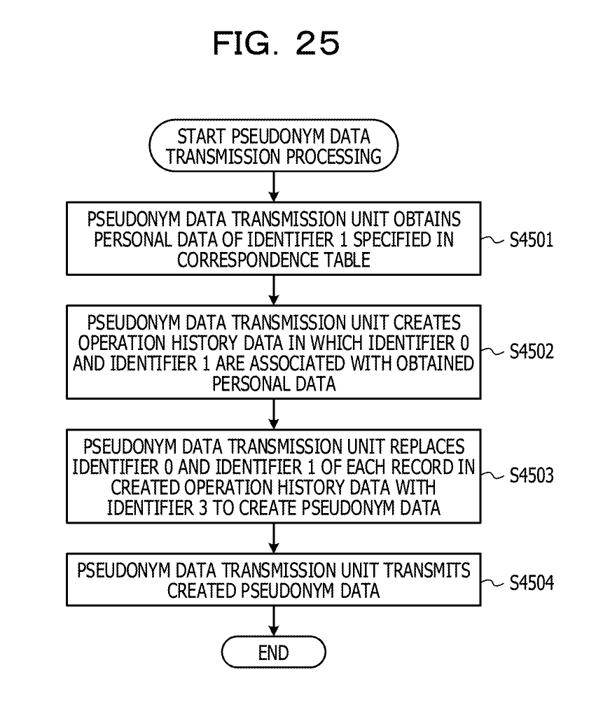

FIG. 25 is a flowchart for illustrating pseudonym-data transmission processing performed by the pseudonym-data transmission unit 45. In FIG. 25, the pseudonym-data transmission unit 45 obtains personal data of the identifier 1 specified in the correspondence table 5c (step S4501). The pseudonym-data transmission unit 45 may extract the identifier 0 of a record indicating permission of provision of personal data from among the records of the identifiers 1 specified on the correspondence table 5c in the association setting information DB 4k and may extract the record of an identifier 1 associated with the extracted identifier 0 from the history data DB 4h.

The pseudonym-data transmission unit 45 creates the operation history data 4hw in which the identifier 0 and the identifier 1 are associated with the obtained personal data (step S4502).

The pseudonym-data transmission unit 45 replaces the identifier 0 and the identifier 1 of each record in the created operation history data 4hw with the identifier 3 to create the pseudonym data 4pdt (step S4503). The pseudonym-data transmission unit 45 obtains the value of the identifier 3 from the identifier 3 list 4g by obtaining the record number in the sale setting information table 4f using the identifier 0 in the operation history data 4hw. The pseudonym-data transmission unit 45 replaces the identifier 0 and the identifier 1 in the operation history data 4hw with the identifier 3 to create the temporal ID.

The pseudonym-data transmission unit 45 transmits the created pseudonym data 4pdt to the association apparatus 6t (step S5404). The pseudonym-data transmission unit 45 transmits the pseudonym data 4pdt using the address information on the association apparatus 6t specified by the purchase request 5r and terminates the pseudonym-data transmission processing.

In the above description, the request destination check and the maximum number check are performed by the checking unit 43 of the data holder apparatus 4t. The maximum number check of the checking process may be performed by the mediation server 5t.

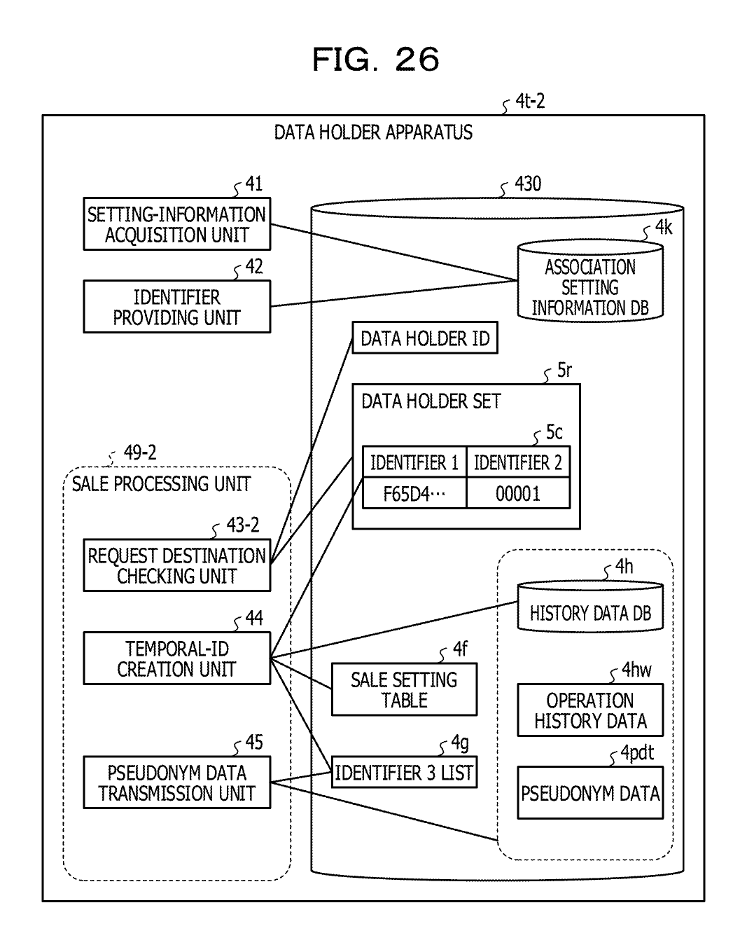

FIG. 26 is a diagram for illustrating a second functional configuration example of the data holder apparatus 4t. In FIG. 26, a data holder apparatus 4t-2 includes processing units including a setting-information acquisition unit 41, an identifier providing unit 42, a request destination checking unit 43-2, a temporal-ID creation unit 44, and an pseudonym-data transmission unit 45. The processing units 41 to 45 are implemented by processing that programs installed in the data holder apparatus 4t-2 cause the CPU 411 of the data holder apparatus 4t-2 to execute.

The data holder apparatus 4t-2 in the second functional configuration example includes a request destination checking unit 49-2 that performs only request destination check unlike the checking unit 49 that performs request destination check and maximum number check in the first functional configuration example. The other processing units are the same as the processing units in the first functional configuration example.

The data holder apparatus 4t-2 receives a purchase request 5r with a data holder set equal to or less than the maximum number of associations via the mediation server 5t. For this reason, the data holder apparatus 4t-2 does not perform the maximum number check. The second functional configuration example is the same as the first functional configuration example except that the maximum number check is not performed, and a detailed description will be omitted.

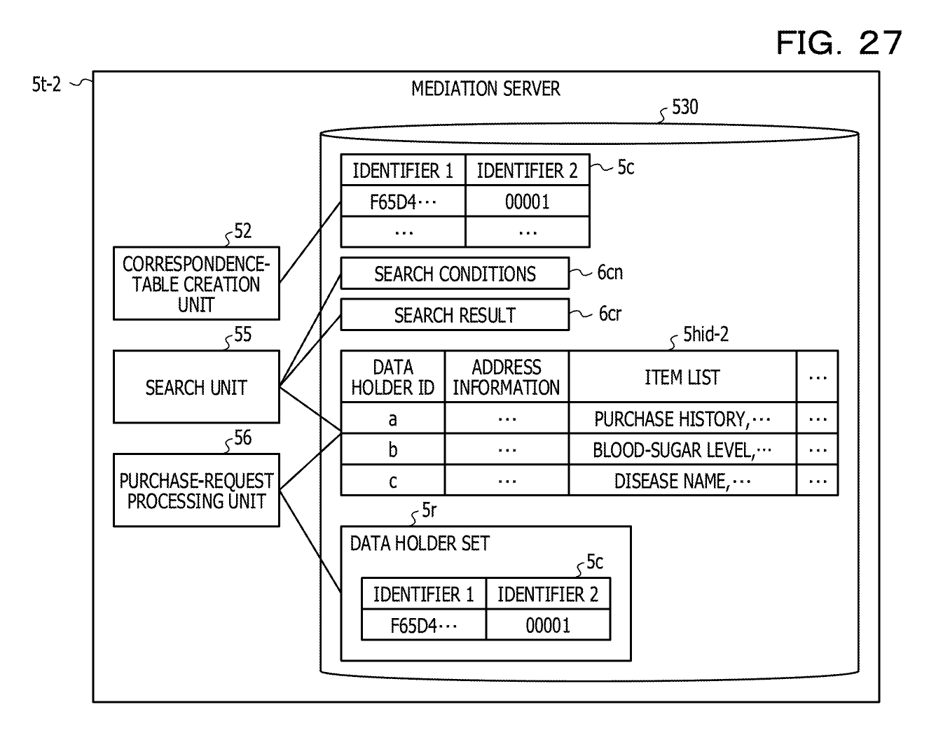

FIG. 27 is a diagram illustrating a second functional configuration example of the mediation server 5t. In FIG. 27, a mediation server 5t-2 includes processing units including a correspondence-table creation unit 52, a search unit 55, and a purchase-request processing unit 56. The processing units 52 and 56 are implemented by processing that programs installed in the mediation server 5t-2 cause the CPU 511 of the mediation server 5t-2 to execute.

The storage unit 530 stores the correspondence table 5c, search conditions 6cn, a search result 6cr, a data-holder information table 5hid-2, the purchase request 5r, and so on.

Only differences from the first functional configuration of the mediation server 5t will be described, and descriptions of the same configuration will be omitted. The mediation server 5t includes the search unit 55, unlike the first functional configuration.

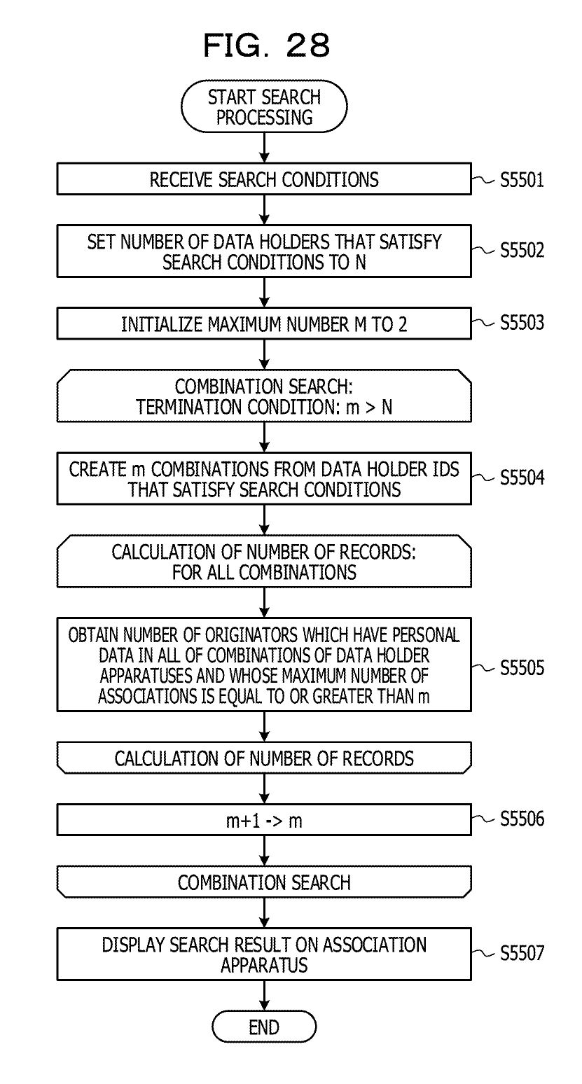

Upon receiving the search conditions 6cn from the association apparatus 6t, the search unit 55 obtains all data holder sets that satisfy the search conditions 6cn to create the search result 6cr and displays the search result 6cr on the association apparatus 6t. The details of the search processing performed by the search unit 55 will be described with reference to FIG. 28. The purchase-request processing unit 56 creates a purchase request 6r based on selection of the data purchaser 6u made based on the search result 6cr and transmits the purchase request 6r to the data holder apparatus 4t.

In the second functional configuration, the data-holder information table 5id-2 differs from the second functional configuration.

The data-holder information table 5id-2 includes an item list in addition to the items in the first functional configuration. The item list is a list of item names of personal data that each data holder apparatus 4t manages. The item list may be obtained when the data holder apparatus 4t is registered.

FIG. 28 is a flowchart for illustrating search processing performed by the search unit 55. In FIG. 28, upon receiving the search conditions 6cn from the association apparatus 6t (step S5501), the search unit 55 sets the number of data holders that satisfy the search conditions 6cn to N (step S5502). The search unit 55 initializes the maximum number m to 2 (step S5503) and repeats the combination search from steps S5504 to S5506 until the maximum number m becomes greater than the number of data holders, N.

The search unit 55 creates m combinations using the data holder IDs that satisfy the search conditions 6cn with reference to the data-holder information table 5hid-2 (step S5504). The search unit 55 specifies data holder IDs that satisfy the search conditions 6cn with reference to the item list in the data-holder information table 5hid-2 and creates all the m combinations using the specified data holder IDs.

The search unit 55 obtains the number of originators 3u which have personal data in all of the combined data holder apparatuses 4t and whose maximum number of associations is equal to or greater than the maximum number m for each combination (step S5505). The search unit 55 obtains the number of originators 3u from the number of records in the correspondence table 5c for each data holder apparatus 4t and stores the combination of data holder IDs, the obtained item names, and the number of originators 3u (the number of records) in the storage unit 530.

Upon obtaining the number of originators 3u for all the combinations, the search unit 55 increments the maximum number m by 1 (step S5506) and repeats the above processing from step S5504 until the maximum number m incremented by 1 exceeds the number of data holders, N.

When the maximum number m incremented by 1 exceeds the number of data holders, N, the search unit 55 terminates the combination search described above. The search unit 55 creates a search result from the combination of data holder IDs, the obtained item names, and the number of originators 3u (the number of records) for each combination, obtained by the above processing, with reference to the storage unit 530, displays the search result on the association apparatus 6t (step S5507), and terminates the search processing.

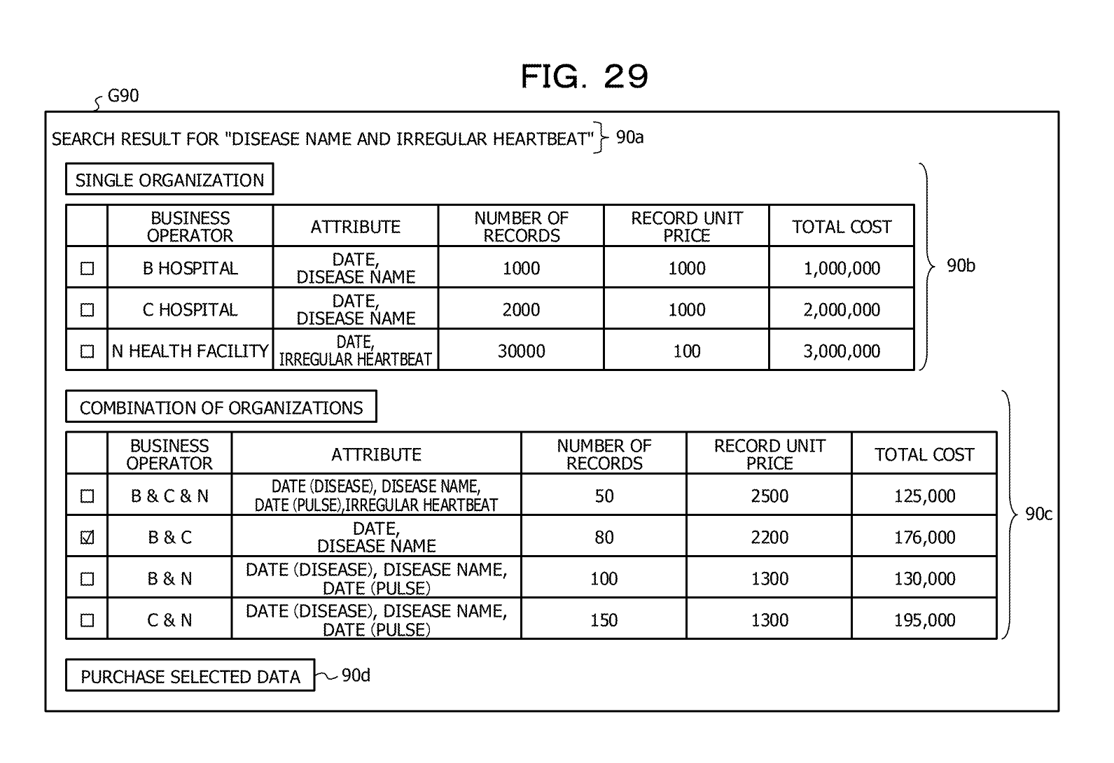

FIG. 29 is a diagram illustrating a screen example of the search result. FIG. 29 illustrates a screen G90 of a search result displayed on the association apparatus 6t of the data purchaser 6u. This is searched for “disease name AND irregular heartbeat”. The screen G90 includes a display area 90a, a first selection area 90b, a second selection area 90c, and a purchase button 90d.

The display area 90a is an area to display search conditions that the data purchaser 6u sets. The first selection area 90b is a selection area for purchasing personal data from a single organization. The second selection area 90c is a selection area for purchasing personal data from two or more organizations.

The first selection area 90b displays a table including check box, business operator, attribute, the number of records, record unit price, total cost, and any other items. The data purchaser 6u selects a business operator from which personal data is to be purchased by checking the check box by reference to business operator, attribute, the number of records, record unit price, total cost, and other information.

The second selection area 90c also displays a table including check box, business operator, attribute, the number of records, record unit price, total cost, and any other items. Unlike the first selection area 90b, the business operator in the second selection area 90c displays two or more organizations. The data purchaser 6u selects a business operator from which personal data is to be purchased by checking the check box by reference to business operator, attribute, the number of records, record unit price, total cost, and other information.

The purchase button 90d is a button for the purchase-request processing unit 56 to transmit the purchase request 6r to the mediation server 5t based on information selected by the data purchaser 6u when pressed by the data purchaser 6u.

As described above, when associating the record of the personal data on the same individual (originator 3u) among two or more data holder apparatuses 4t, the present embodiment allows limiting the number of data holder apparatuses 4t from which the personal data is to be purchased.

In the present embodiment, the temporal ID (identifier 3) corresponds to one example of a transaction ID, and the purchase request 6r and the purchase request 5r correspond to examples of a provision request to provide personal data.

It is to be understood that the present disclosure is not limited to the disclosed embodiments and that various modifications and changes may be made without departing from the scope of the accompanying claims. All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An apparatus for providing information comprising:
a memory configured to store personal data; and
a processor coupled to the memory and configured to, in response to reception of a provision request to provide personal data on a data originator:
create a transaction identifier (ID) based on an identifier of the data originator and a combination of identifiers of holders of personal data on two or more request destinations,
associate the personal data stored in the memory with the transaction ID, and
provide the personal data associated with the transaction ID to an apparatus that uses the personal data.

2. The apparatus for providing information according to claim 1, wherein the processor is configured to:
determine whether the combination of the identifiers of the holders included in the provision request includes an identifier of the information provision apparatus,
when the combination includes the identifier of the information provision apparatus, create the transaction ID, and
when the combination does not include the identifier of the information provision apparatus, transmit an error.

3. The apparatus for providing information according to claim 1, wherein the processor is configured to:
determine whether a number of the identifiers of the holders included in the combination is equal to or less than a threshold,
when the number is equal to or less than the threshold, create the transaction ID, and
when the number is greater than the threshold, transmit an error.

4. The apparatus for providing information according to claim 3,
wherein the processor determines whether the number of the identifiers of the holders is equal to or less than the threshold when the combination of the identifiers of the holders included in the provision request includes the identifier of the information provision apparatus.

5. A method for providing information, the method comprising:
in response to reception of a provision request to provide personal data on a data originator,
creating a transaction identifier (ID) based on an identifier of the data originator and a combination of identifiers of holders of personal data on two or more request destination;
associating the personal data stored in the memory with the transaction ID; and
providing the personal data associated with the transaction ID to an apparatus that uses the personal data.

6. The method for providing information according to claim 5, further comprising:
determining whether the combination of the identifiers of the holders included in the provision request includes an identifier of the information provision apparatus;
creating the transaction ID when the combination includes the identifier of the information provision apparatus; and
transmitting an error when the combination does not include the identifier of the information provision apparatus.

7. The method for providing information according to claim 5, further comprising:
determining whether a number of the identifiers of the holders included in the combination is equal to or less than a threshold;
creating the transaction ID when the number is equal to or less than the threshold; and
transmitting an error when the number is greater than the threshold.

8. A system for providing information, comprising:
a personal-data requestor apparatus; and
a request destination apparatus that holds the personal data,
wherein, in response to reception of a search condition, the personal-data requestor apparatus
specifies data holder apparatuses that satisfy the search condition with reference to an item name in personal data that a plurality of data holders individually hold, the personal data being stored in a memory,
creates a personal-data provision request that specifies one of combinations selected from the specifies data holder using a value equal to or less than a threshold, and
transmits the created provision request to the request destination apparatuses of the combination, and
wherein, in response to reception of a provision request to provide personal data on a data originator, the request destination apparatus
holds the personal data,
creates a transaction identifier (ID) based on an identifier of the data originator and a combination of identifiers of two or more request destination apparatuses,
associates the personal data with the transaction ID, and
provides the personal data associated with the transaction ID to an apparatus that uses the personal data.
